(19) United States
(12) Patent Application Publication
(10) Pub. No.: US 2022/0227949 A1
(43) Pub. Date: Jul. 21, 2022

(54) BIAXIALLY AND MONOAXIALLY ORIENTED FILMS, LAMINATES AND OTHER STRUCTURES INCLUDING STARCH-BASED POLYMERIC MATERIALS

(71) Applicant: BIOLOGIQ, INC., Idaho Falls, ID (US)

(72) Inventors: Donald R. ALLEN, Idaho Falls, ID (US); Leopoldo V. CANCIO, Vero Beach, FL (US); Fehime Vatansever OZALTUN, Idaho Falls, ID (US); Bruno R. PEREIRA, Houston, TX (US)

(21) Appl. No.: 17/573,403

(22) Filed: Jan. 11, 2022

Related U.S. Application Data
(60) Provisional application No. 63/138,161, filed on Jan. 15, 2021.

(51) Int. Cl. C08J 5/18; C08L 3/02; B29C 48/00; B29C 48/08

(52) U.S. Cl. CPC C08J 5/18; C08L 3/02; B29C 48/0018; B29C 48/022; B29C 48/08; B29L 2007/008; C08J 2303/02; C08J 2423/04; C08J 2423/10; C08J 2433/26; B29K 2003/00; C08L 2205/035

(57) ABSTRACT

Described herein are starch-based materials, and formulations including such for use in directional alignment extrusion processes. The present compositions exhibit critical shear stress characteristics that allow extrusion at high shear rates and line speeds, without onset of melt flow instability. The present compositions provide sufficient melt strength to allow such compositions to be directionally oriented by stretching the heated polymer (e.g., the polymer melt) following initial extrusion, directionally aligning the molecular chains of the heated polymer blend in the machine-direction, the cross-direction, or both. In an embodiment, the starch-based material is blended with one or more thermoplastic materials having desired melt flow index value(s), which serves as a diluent, allowing the very viscous starch-based component to be processed under such conditions. The starch-based materials (and masterbatches thereof) may exhibit high molecular weight, high shear sensitivity, strain hardening behavior, and/or a very high critical shear stress (e.g., at least 125 kPa).

### CROSS-REFERENCE TO RELATED APPLICATIONS

The present application claims the benefit of U.S. Application No. 63/138,161 (21132.32), filed Jan. 15, 2021, which is herein incorporated by reference in its entirety.

The present application also incorporates by reference each of U.S. application Ser. No. 17/327,536 (21132.31.1) filed May 21, 2021, U.S. application Ser. No. 17/327,577 (21132.31.2) filed May 21, 2021, U.S. application Ser. No. 17/327,590 (21132.31.3) filed May 21, 2021, U.S. application Ser. No. 16/925,747 (21132.30.1), filed Jul. 10, 2020; U.S. application Ser. No. 16/925,952 (21132.28.1.1) filed Jul. 10, 2020; U.S. application Ser. No. 16/925,705 (21132.27.1.1) filed Jul. 10, 2020; U.S. patent application Ser. No. 16/425,397 (21132.20.1) filed May 29, 2019 (now U.S. Pat. No. 11,149,144); U.S. patent application Ser. No. 16/391,909 (21132.14.1) filed Apr. 23, 2019 (now U.S. Pat. No. 11,111,355); U.S. application Ser. No. 15/456,295 (21132.12.1) filed Jun. 28, 2019 (now U.S. Pat. No. 10,920,044), U.S. application Ser. No. 15/691,588 (21132.7) filed on Aug. 30, 2017 (now U.S. Pat. No. 11,046,840); U.S. application Ser. No. 14/853,725 (21132.8) filed on Sep. 14, 2015 (now abandoned); U.S. Provisional Patent Application No. 62/187,231 filed on Jun. 30, 2015; U.S. application Ser. No. 14/853,780 (21132.6) filed on Sep. 14, 2015 (now abandoned); U.S. application Ser. No. 15/481,806 (21132.1) and Ser. No. 15/481,823 (21132.2), both filed on Apr. 7, 2017 (now U.S. Pat. Nos. 10,995,201 and 10,919,203, respectively); U.S. Provisional Patent Application No. 62/440,399 (21132.10) filed on Dec. 29, 2016; U.S. Provisional Patent Application No. 62/442,432 (21132.11) filed on Jan. 4, 2017; U.S. application Ser. No. 16/456,303 (21132.9.1) filed on Jun. 28, 2019 (now U.S. Pat. No. 10,752,759); and U.S. patent application Ser. No. 15/836,555 (21132.4.1), filed Dec. 8, 2017 (now U.S. Pat. No. 11,111,363).

### BACKGROUND

Traditional petrochemical-based plastics are formulated to be strong, lightweight, and durable. For this reason, they are used in large quantities in countless consumer products. However, these plastics are generally not sourced from sustainable materials, are typically not biodegradable to any significant extent, and as a result, hundreds of millions of tons of plastic persists in landfills or in other natural environments (oceans, other waterways, in soil, etc.). In trying to reduce the amount of plastic waste, some articles typically produced using petrochemical-based plastics are being produced using more rapidly biodegradable materials, and/or from a fraction of components sourced from renewable sources.

Many such plastic materials are manufactured in the form of stretched materials where the molecular chains of the polymers from which the materials is made are directionally aligned in the machine-direction (MD), the cross-direction (CD) (also referred to as transverse-direction (TD)), or where some molecular chains are MD oriented and others are CD oriented. Examples of such materials include biaxially oriented polypropylene (BOPP), biaxially oriented polyethylene (BOPE), machine-direction oriented (MDO) materials, cross-direction oriented (CDO) materials, and the like. Such materials are manufactured by drawing or stretching the materials during manufacture, while in a heated state, at high rates. Such drawing at high rates require very specific rheological characteristics as to melt strength, extensional or elongational viscosity, and the like for the composition, in order to accommodate processing.

Such stretched polymeric film, sheet, or other materials tend to exhibit increased strength (e.g., that may be directional depending on the direction of any stretching), allowing such materials to be processed at high speeds, even at low gauges. In biaxially oriented materials, the resulting material can provide excellent strength in both MD and CD directions. While there has been some advancement made in incorporating renewably sourced components into some monolithic plastic articles, and even standard plastic film materials (without any directional orientation), little if any success has been achieved in incorporating such renewable components into directionally oriented polymeric materials. In particular, there has been little if any success with incorporation of starch-based polymeric materials into such directionally oriented materials. Such is due in no small part to the fact that incorporation of typical starch materials into a polyolefin resin blend normally results in decreased strength properties, and significantly affects the rheological properties, making it difficult, if not impossible as a practical matter for the formulation to provide the necessary extensional or elongational viscosity and melt strength characteristics necessary for the formulation to be capable of being processed under such conditions typical of a directionally oriented/aligned extrusion process. For example, the relatively high molecular weight, and complex molecular characteristics associated with the presence of both amylose and amylopectin in such starch materials, as well as other characteristics of conventional starches make incorporation of such materials into directionally aligned materials difficult.

As noted above, most petrochemical-based plastics materials (including those used in production of directionally oriented films and other materials), are typically not readily biodegradable. Examples of such include, but are not limited to polypropylene and polyethylene. Such non-biodegradable characteristics are typically the case even for so called “green” versions of such materials (e.g., Green PE made by Braskem), which may be sourced from renewable sources, rather than petro-chemical feedstocks. Such “green” versions of the plastics differ little (if at all) in physical properties from their fossil-fuel derived cousins, and can be differentiated, e.g., by minor differences, such as their elevated C¹⁴ vs. C¹² content, etc. Even where it is possible to source some components of a plastic material from a renewable source, Applicant is not aware of any significant commercial attempt to date to incorporate starch-based polymeric materials into manufacture of directionally aligned films, sheets or other articles, particularly where such article would not exhibit detrimental physical properties as a result of such incorporation.

It would be an advantage in the art to provide directionally aligned films, sheets, or other articles, and associated methods for manufacture of such, where such could include starch-based polymeric materials, where such materials would exhibit strength and other physical characteristics at least comparable to existing directionally aligned films or sheets. For example, it would be advantageous if inclusion of such starch-based polymeric materials were to enhance, or at least not significantly detract from, the mechanical properties of such directionally oriented films, sheet, or the like, as compared to the base resin material, used alone. It would be a further advantage if such compositions could be processed into directionally oriented films, sheet or the like on conventional equipment, at commercially employed draw rates during directional alignment, and overall commercial production line speeds.

### SUMMARY

Applicant's copending applications as incorporated by reference above disclose starch-based polymeric materials (e.g., thermoplastic starch materials) that can be blended with various plastic resin materials, while substantially maintaining desired strength and other physical characteristics of the material with which the renewable starch-based material is blended. Such starch-based materials, available under the tradename NuPlastiQ, are believed to achieve a strong intermolecular bond between the starch-based material, and the plastic resin with which it is blended. Such strong bonding is in contrast to what is achieved in numerous prior art attempts to blend such plastic resins with starch or starch-based materials, where the starch or starch-based material simply acts as a filler, typically reducing strength and negatively affecting other physical properties.

As described in Applicant's U.S. Application No. 63/033,676 (21132.31), U.S. application Ser. No. 17/327,536 (21132.31.1), U.S. application Ser. No. 17/327,577 (21132.31.2), and U.S. application Ser. No. 17/327,590 (21132.31.3), Applicant has now found that at least some grades of their starch-based polymeric material (e.g., having very high molecular weights), can be formed into thin fibers (e.g., less than 16 microns), e.g., such as are useful in the formation of nonwoven web substrates (e.g., for use in, but not limited to, diapers, sanitary napkins, disposable drapes, hospital gowns, surgical and other masks, pads, and the like). Extensional or elongational viscosity (used interchangeably) characteristics of such compositions is a very important characteristic or property of any given formulation, in being able to effectively process such, in the manufacture of such thin fibers.

In the manufacture of a directionally oriented film, sheet, or similar article, melt strength is of similar importance. Melt strength refers to the resistance of a polymer melt to stretching. Melt strength depends on various factors, particularly chain entanglements and resistance to untangling when under strain. Molecular weight, molecular weight distribution, and branching characteristics of the components included in the formulation affect melt strength, with increased branching and longer chain lengths generally increasing melt strength.

For similar reasons that there has been little or no commercialization of incorporation of starch into fibers for making nonwoven webs, there has been no incorporation of starch into directionally oriented films, sheet, or similar articles, as addition of such results in a formulation that does not exhibit the necessary melt strength or is otherwise not conducive to processing within such manufacturing processes. For example, the literature suggests that typical starches would exhibit no strain hardening, and would lack other important characteristics (e.g., softness). For example, one would expect it to be impossible to achieve the needed rheological characteristics (particularly relative to melt strength and elongational viscosity) to be able to directionally orient a composition including a starch-based polymer in a typical BOPP, BOPE, MDO, or CDO manufacturing process.

According to one embodiment, the present invention is directed to a method for extruding and directionally aligning or orienting (used interchangeably) a composition that includes a starch-based polymeric material by providing such a starch-based polymeric material, and melt extruding the composition through a die at a suitable temperature to form a film or sheet, and with the blend as a polymer melt, stretching the film or sheet in at least one of the machine-direction or the cross-direction to orient molecular chains of the composition in at least one of the machine-direction (MD) or cross-direction (CD), where the composition exhibits shear stress through the die that is below an onset of melt flow instability of the composition, and exhibits sufficient melt strength to undergo the MD and/or CD drawing, to produce directionally oriented films or sheets that include the starch-based polymeric material. In an embodiment, the starch-based polymeric material may have a relatively high weight and/or number average molecular weight, e.g., greater than 1, 2, 3, 4, or 5 million, although lower molecular weight starch-based materials (e.g., molecular weight of 1 million or perhaps even less) may also prove suitable for use. By way of example, in an embodiment, the starch-based polymeric material may have a weight average molecular weight of 3 to 20 million, or 5 to 16 million, although it will be apparent that lower molecular weight values may also be suitable for use. By way of further example, an exemplary starch from which the starch-based polymeric material is formed (e.g., formed from the starch and a plasticizer) may have a weight average molecular weight of at least 1, 2, 3, 4 or 5 million, such as 3 to 10 million, or 5-7 million. The starch-based polymeric material may be formed from a starch having a particular amylose content, e.g., at least 10%, at least 20%, or at least 30% amylose content, such as from 20% to 70%, or from 30% to 50% amylose. Any suitable extrusion temperature may be used, such as at least 130° C. (e.g., 130° C. to 250° C.).

For example, at a shear rate exemplary of commercial manufacturing lines (e.g., process shear rate of about 200 sec⁻¹, with higher shear rates at critical points in the process, for example, up to 1500 sec⁻¹). In any case, under such conditions, it is important that the formulation be maintained below the onset of melt flow instability, e.g., ideally below 100 kPa for a polypropylene dominated formulation. As will be apparent to those of skill in the art, melt flow instability occurs when the critical shear stress (e.g., about 100 kPa for a typical polypropylene) is exceeded. Such critical shear stress values are independent of temperature, and depend on the material characteristics of the formulation (e.g., molecular structures, etc.). By way of example, above such critical shear stress, gross surface irregularities associated with inlet fracture and/or land fracture can occur, resulting in undesirable or unusable manufactured product, due to the irregularities in the extruded product surface. Other characteristics that can be associated with melt flow instability (which are also undesirable) include, but are not limited to draw resonance (which causes pulsation in extruded thickness), and secondary flows (which causes interphase problems in multilayer extrusion products). The present disclosure is directed to formulations and methods that allow directional alignment extrusion of starch-based polymer containing compositions, where such melt flow instability problems can be avoided or minimized.

Under typical conditions in a BOPP or similar directional alignment extrusion process, with the particular formulations as described herein, viscosity characteristics may depend on extrusion temperature, temperature during MD and/or CD alignment, as well as shear rate and/or strain rates imposed during the process. By way of example, in an MD orientation portion of a given process, the heated polymer blend may be oriented below the melting point of the blend, but where the blend is certainly in a softened state. By way of example, the composition may exhibit a shear viscosity or BPI value (defined hereafter) of no more than about 600 Pa·s, no more than 500 Pa·s, no more than 475 Pa·s, at least 300 Pa·s, at least 375 Pa·s, at least 400 Pa·s, at least 430 Pa·s, at least 440 Pa·s or at least 450 Pa·s at a shear rate of 200 sec⁻¹ and at a temperature of 190° C., even while including a substantial fraction of the starch-based polymeric material having relatively high molecular weight, where the process is effective to produce stretched, directionally oriented films or sheets including the starch-based polymeric material. It will be apparent that the optimal shear viscosity may differ, depending on formulations and/or the actual equipment configuration used for manufacture of the directionally oriented film.

In an embodiment, the starch-based polymeric material is blended with a thermoplastic polymeric diluent material capable of further plasticizing the starch-based polymeric material, e.g., a polypropylene having a higher melt flow index than the starch-based material itself (e.g., at least 1 g/10 min, at least 2, at least 3, for example from 1 to 5, in units of g/10 min, under standard conditions (e.g., 230° C. under a load of 2.16 kg for polypropylenes, or 190° C. under a load of 2.16 kg for polyethylenes or other materials). In an embodiment, more than one such polymeric diluent material is included, e.g., having an even higher melt flow index values (e.g., at least 10 g/10 min, at least 20 g/10 min or at least 35 g/10 min, for example, from 10 to 50 g/10 min). Applicant has discovered that although the presently prepared starch-based polymeric materials can have a very high molecular weight (and thus extremely high viscosity characteristics), which can make melting and subsequently extruding difficult, particularly while maintaining sufficient melt strength, the particular starch-based polymeric materials as described herein: (i) appear to be strain hardening (while other starches appear to be strain thinning); (ii) exhibit high shear sensitivity, i.e., the materials are shear thinning, thus that the shear rate can be used to dramatically improve flow characteristics; (iii) exhibit excellent responsiveness to diluents/plasticizers (where the addition of a small amount of such polypropylene or similar thermoplastic polymer having a given melt flow index also dramatically affects flow characteristics); and (iv) exhibit relatively high critical shear stress characteristics (e.g., higher than polypropylene). In addition, the prepared starch-based polymeric materials exhibit (v) excellent responsiveness to extrusion temperature (where the material exhibits significantly decreased viscosity as extrusion temperature increases).

Such characteristics do not appear to be inherent within other starch-based polymeric materials, and indeed, at least some such characteristics appear to be opposite from those of conventional starch-based polymeric materials (e.g., the present starch-based materials appear to be strain hardening vs. other TPS's being strain thinning). Strain hardening vs. strain thinning is not to be confused with shear thickening vs. shear thinning. For example, shear thickening or shear thinning has to do with how the material behaves when shear is applied (e.g., does it become thicker or thinner upon application of shear). In contrast, strain hardening vs. strain thinning has to do with how the material behaves as a function of time, under strain. If the material exhibits increased extensional or elongational viscosity over time during the drawing procedure, then it is strain hardening. It can be inferred from the literature that typical starch materials, while of course used for thickening, do not exhibit strain hardening behavior, where they would increase in extensional or elongational viscosity as the material is being drawn within the process. Rather, existing starch materials seem to thin during drawing, causing the material to draw to a point and break, and/or have insufficient melt strength. In addition, the particular starch from which the starch-based polymeric NuPlastiQ material is formed may affect such characteristics (e.g., selection of different grades of corn starch, cassava starch, potato starch, etc. used to make the starch-base material may affect the rheology of the resulting material, as described in U.S. Application No. 63/033,676 (21132.31), U.S. application Ser. No. 17/327,536 (21132.31.1), U.S. application Ser. No. 17/327,577 (21132.31.2), U.S. application Ser. No. 17/327,590 (21132.31.3), each of which is herein incorporated by reference in its entirety.

NuPlastiQ starch-based materials also exhibit lower water content, as compared to various starch-based materials described in the literature at least for use in spinning (e.g., <2% total water content, including bound water, as compared to 5% or more, for materials described in the literature used in fiber spinning). As noted above, fiber spinning processes may share some similar requirements with directional alignment extrusion processes.

Another embodiment is directed to polymeric blends suitable for use in forming directionally oriented film or sheet materials. Such a composition includes the starch-based polymeric material, and a thermoplastic polymeric diluent material having a melt flow index configured to further plasticize the starch-based polymeric material, to provide overall desired rheological characteristics (e.g., including needed melt strength). The two components are typically intimately dispersed with one another. In an embodiment, the starch-based polymeric material may be present in an amount of up to 75%, up to 60%, up to 50%, or up to 40% by weight of the blend. The thermoplastic polymer may be present in an amount of up to 95% or up to 90% by weight of the blend (e.g., more typically up to 75%). Of course, in other embodiments, it may be possible to further increase the percentage of starch content, e.g., by adjusting other manufacturing parameters as mentioned herein (e.g., increasing process temperature, within the limits of degradation of the NuPlastiQ or other starch-based polymeric material, increasing shear rate, etc.).

Another embodiment is directed to a directionally aligned film or sheet material including the starch-based polymeric material (e.g., NuPlastiQ) described herein, and the thermoplastic polymeric material having a melt flow index that is configured to plasticize the starch-based polymeric material, and otherwise achieve the necessary melt strength characteristics needed during manufacture. The components may be intimately dispersed together. Within such film or sheet, the molecular chains of the thermoplastic polymeric material and/or the starch-based polymeric material may be aligned in the machine-direction, the cross-direction, or both as a result of stretching of the polymer melt that occurs during manufacture.

Another embodiment is directed to a method for increasing the critical shear stress threshold of an extrusion formulation, where the method includes providing a thermoplastic extrusion formulation having an initial critical shear stress of a given value (e.g., less than 300 kPa, less than 200 kPa, or less than 125 kPa, such as about 100 kPa), and adding to such formulation a starch-based polymeric material having a critical shear stress that is greater than that of the thermoplastic extrusion formulation. By way of example, the starch-based polymeric material itself may have a critical shear stress of greater than 200 kPa, or greater than 300 kPa. Even when blended as part of a masterbatch, addition of such may allow increases to the critical shear stress to values greater than 100 kPa, such as to 125 kPa, or 150 kPa. In any case, the result is that the starch-based polymeric material increases the initial critical shear stress of the formulation. In an embodiment, the starch-based polymeric material may be added as part of a masterbatch (e.g., a NuPlastiQ BioBlend®), where the starch-based polymeric material is already blended with a given thermoplastic material. Such masterbatch blend may have a lower critical shear stress than the starch-based polymeric material alone, but still higher than the formulation to which it is being added. By way of example, such a masterbatch “BioBlend” may include 50% of the starch-based polymeric material. By way of further example, the masterbatch BioBlend may have a critical shear stress value that is at least 110 kPa, at least 115 kPa, at least 120 kPa, at least 125 kPa, at least 150 kPa, at least 175 kPa or at least 200 kPa.

While the NuPlastiQ starch-based polymers described herein are an example of a starch-based material that can provide the benefits described herein, it will be appreciated that the scope of the present invention extends broadly, to other starch-based materials that might exhibit similar characteristics (e.g., developed at some future time), or even to a material that may be synthesized from starting materials other than starch, which may achieve similar results due to the presence of the same or similar chemical structures or functional groups, as the presently described starch-based materials. For example, if a material having a chemical structure similar or identical to NuPlastiQ were synthesized (e.g., in a reactor) starting from non-starch materials, such is also within the scope of the present invention.

Further features and advantages of the present invention will become apparent to those of ordinary skill in the art in view of the detailed description of preferred embodiments below.

### BRIEF DESCRIPTION OF THE DRAWINGS

A more particular description of the invention briefly described above will be rendered by reference to specific embodiments as illustrated in the appended drawings. Understanding that these drawings depict only typical embodiments of the invention and are therefore not to be considered limiting of its scope, the invention will be described and explained with additional specificity and detail through the use of the accompanying drawings.

FIG. 1 schematically illustrates a typical system for manufacture of a biaxially oriented film.

FIG. 2 shows information relative to crystal orientation and morphology for MDO and TDO films.

### DETAILED DESCRIPTION

### I. Definitions

All publications, patents and patent applications cited herein, whether supra or infra, are hereby incorporated by reference in their entirety to the same extent as if each individual publication, patent or patent application was specifically and individually indicated to be incorporated by reference. Such incorporation by reference includes the prosecution history of Applicant's earlier patents, many of which have been issued.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

The terms “a,” “an,” “the” and similar referents used in the context of describing the inventive features (especially in the context of the following claims) are to be construed to cover both the singular and the plural, unless otherwise indicated herein or clearly contradicted by context. Thus, for example, reference to a “starch” can include one, two or more starches.

The terms “directionally oriented films”, “directionally oriented sheets” or the like, as used herein, refers to films, sheets or similar materials (e.g., including nonwovens) where the molecular chains of the thermoplastic polymeric material and/or the molecular chains of the starch-based polymeric material are substantially aligned in the machine-direction, the cross-direction, or both, as a result of stretching of the polymer melt during the manufacturing process. Particular values and specific characteristics for such orientation and directional alignment will be familiar to those of ordinary skill in the art, and the terms as used herein encompass such. Examples of such directionally oriented materials include but are not limited to BOPP, BOPE, MDO materials, and CDO materials. It is not necessary that alignment of such chains be complete, e.g., but simply that the stretching process untangles and/or reorients at least some fraction of the chains from their initially tangled and relatively random initial orientation, so that an increased fraction of such chains are oriented more in-line with the machine direction or the cross-direction. In biaxially oriented materials, some chains are reoriented towards the machine-direction, while other chains are reoriented towards the cross-direction. Such alignment alters the strength and other physical characteristics of the resulting film or sheet, as recognized by those of skill in the art.

Unless otherwise stated, all percentages, ratios, parts, and amounts used and described herein are by weight, including molecular weights—i.e., weight average molecular weights, vs. number average molecular weights.

Numbers, percentages, ratios, or other values stated herein may include that value, and also other values that are about or approximately the stated value, as would be appreciated by one of ordinary skill in the art. A stated value should therefore be interpreted broadly enough to encompass values that are at least close enough to the stated value to perform a desired function or achieve a desired result, and/or values that round to the stated value. The stated values include at least the variation to be expected in a typical manufacturing process, and may include values that are within 25%, 15%, 10%, within 5%, within 1% etc. of a stated value.

All numbers expressing quantities of ingredients, constituents, conditions, and so forth used in the specification and claims are to be understood as being modified in all instances by the term “about”. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Some ranges are disclosed herein. Additional ranges may be defined between any values disclosed herein as being exemplary of a particular parameter. All such ranges are contemplated and within the scope of the present disclosure. Further, recitation of ranges of values herein is intended to serve as a shorthand method of referring individually to each separate value falling within the range. Unless otherwise indicated herein, each individual value is incorporated into the specification as if it were individually recited herein.

The phrase ‘free of’ or similar phrases as used herein means that the composition comprises 0% of the stated component, that is, the component has not been intentionally added to the composition. However, it will be appreciated that such components may incidentally form under appropriate circumstances, may be incidentally present within another included component, e.g., as an incidental contaminant, or the like.

The phrase ‘substantially free of’ or similar phrases as used herein means that the composition preferably comprises 0% of the stated component, although it will be appreciated that very small concentrations may possibly be present, e.g., through incidental formation, incidental contamination, or even by intentional addition. Such components may be present, if at all, in amounts of less than 1%, less than 0.5%, less than 0.25%, less than 0.1%, less than 0.05%, less than 0.01%, less than 0.005%, or less than 0.001%.

The term “non-biodegradable” as used herein with regard to a material means that the native material (free of additives added to render it biodegradable) does not degrade (particularly biodegrade), e.g., to carbon dioxide and/or methane to a significant extent in a reasonable limited time period (e.g. one year, 2 years, 3 years, or 5 years) when exposed to various typical disposal conditions, such as sunlight, in the ocean, in a landfill, industrial or other compost conditions, or to specific ASTM conditions intended to evaluate biodegradability (e.g., ASTM D-5511, D-5526, D-5338, D-6691). However, it is understood that given enough time and exposure to conditions of sunlight, oxygen and degrading microbes, most polymeric materials (e.g., even those that are typically considered “non-biodegradable”) will eventually degrade or even biodegrade, usually to some limited extent, over an extended time (e.g., centuries).

The term “biodegradable” as used herein with regard to a material means that the material as described herein does significantly biodegrade (e.g., over 50%) to base molecules such as carbon dioxide, methane and/or water by the action of appropriate microorganisms, within a reasonable limited time frame (e.g., 5 years, 3 years, 2, years, 1 year, etc.) under “ideal” biodegradation conditions (e.g., anaerobic digester, industrial compost, or the like), e.g., such as conditions under various ASTM biodegradability tests (e.g., ASTM D-5511, D-5338, D-6691).

The term “modified” as used, e.g., in describing “modified starch” and the like, refers to physical and/or chemical modifications, including the conversion of a starting starch material to one that includes a lower molecular weight. Applicant's NuPlastiQ material may be considered to comprise a “modified” starch. Starches that may not necessarily fall within the description of the term “modified”, may also be suitable, e.g., where they otherwise exhibit characteristics as described herein. Such mechanical and/or chemical modifications may include mechanical modification of amylopectin starch component(s) to a more linear amylose structure.

By way of example, some of the literature may suggest amylose (15-30% of the starch units) may contain chains with molecular weight from approximately 40,000 and 340,000 Daltons with the chains containing 250 to 2000 anhydroglucose units. Amylose is an unbranched chain which is coiled in the shape of a helix.

Amylopectin (70-85% of the units in starch) contains chains with molecular weight as high as 80,000,000 Daltons. The foregoing descriptions of amylose and amylopectin are merely exemplary, and it will be appreciated that starches having different characteristics may also be suitable for use.

The descriptions herein are merely exemplary, and it will be appreciated that numerous modifications or variations to such starch components are possible. Applicant's NuPlastiQ materials as described herein are examples of a modified starch-based material, having very high molecular weight, available from Applicant. Determination of molecular weight may be through any desired process, e.g., any of various size exclusion chromatography techniques (e.g., gel permeation chromatography (“GPC”) or gel filtration chromatography (“GFC”).

The terms “film” and “sheet” as used herein refer to articles that are generally 2-dimensional, with a thickness that is significantly less than the length and/or width of the article, as will be familiar to those of skill in the art. Such articles may include one or more layers. By way of example, a film or any individual layers thereof can have a thickness of at least 0.001 mm, at least 0.002 mm, at least 0.004 mm, at least 0.01 mm, at least 0.02 mm, at least 0.03 mm, at least 0.05 mm, at least 0.07 mm, at least 0.10 mm, no greater than 2 mm, no greater than 1 mm, no greater than 0.5 mm, no greater than 0.1 mm, from about 0.05 mm to about 0.5 mm, or from 0.02 mm to 0.05 mm. While there may be some overlap in thickness values for film and sheet articles, it will be appreciated that sheet materials are generally thicker than a film, e.g., having a thickness of up to 10 mm, or perhaps more. Those of skill in the art will further appreciate that in a directional alignment process, the as extruded material is generally quite thick, and is thinned down as the polymer melt is drawn in the machine-direction and/or the cross-direction, after initial extrusion.

Unless indicated otherwise, melt flow index values are in units of g/10 min, under standard conditions (e.g., 230° C. under a load of 2.16 kg for polypropylenes, or 190° C. under a load of 2.16 kg for polyethylenes or other materials).

In reference to various standardized tests (e.g., ASTM or other tests), it will be understood that reference to any such standard refers to the latest update (if any) of such standard, unless otherwise indicated. Any such referenced standards are incorporated herein by reference, in their entirety.

### II. Introduction

The present disclosure is directed to, among other things, methods for successfully extruding and directionally aligning a composition that includes a starch-based polymeric material, which may be of very high molecular weight. In an embodiment, the starch-based polymeric material may have a relatively high molecular weight, e.g., greater than 2, 3, 4, or 5 million, such as 3 million to 20 million, or 5 to 16 million). Such values may represent weight average molecular weights. Number average molecular weights may be greater than 1, 2, 3, 4, or 5 million, such as 3 million to 12 million, or 3 million to 10 million, or 5 million to 7 million. The starch material from which the starch-based polymeric material is formed (e.g., formed from the starch and a plasticizer in a reactive extrusion process) may similarly have a weight average molecular weight greater than 1, 2, 3, 4, or 5 million, such as 3 to 10 million, or 5 to 7 million. Mw to Mn ratios (polydispersity) for the starting starch, or the finished starch-based polymeric material may be greater than 1, such as from 1 to 2, 1 to 3, 1 to 4, or even higher.

For example, to be suitable for extrusion processes that include directional alignment of the polymer chains within the composition, the polymer melt needs to be capable of being stretched during such manufacture, so as to align the molecular chains. Such requires particular melt strength characteristics which are not typically provided in many compositions, particularly those that would include significant fractions of a starch-based polymeric material. Even though the contemplated grades of NuPlastiQ as a starch-based polymeric material can have a very high molecular weight (e.g., at least 3 million, 3 to 10 million, 5 to 7 million, 7 to 9 million, or even 10-18 million), Applicant has surprisingly found that it is possible to extrude films, sheets, or similar articles, while directionally aligning the molecular chains in a desired direction (e.g., MD, CD, or both), even where the composition includes significant fractions of such a starch-based polymeric material, at least in part because of the particular characteristics exhibited by the contemplated starch-based polymeric materials. For example, even though this starch-based material exhibits very high molecular weight (and thus extremely high zero shear viscosity (Eta-0, η₀), as well as correspondingly high shear viscosity ηₛ and elongational or extensional η_{E} viscosities), Applicant has discovered that this material also exhibits characteristics that allow it to still be processed in such ways, even under process conditions typical of commercial directional alignment extrusion production systems, where particular selections are made in the operating parameters, and to the composition formulation. For example, Applicant has discovered that this starch-based material exhibits excellent shear sensitivity, so that even though the zero-shear viscosity can be extremely high (e.g., greater than 10⁶ or 10⁷ Pa·s, which is about at least an order of magnitude higher than conventional TPS materials), shear viscosity can quickly be reduced at commercial production line shear rates (e.g., 200 to 1500 s⁻¹), particularly where such is coupled with other “handles” or “levers” that can be adjusted, as noted below.

For example, in addition to excellent shear sensitivity, the starch-based polymeric material has also been found to exhibit excellent responsiveness to thermoplastic diluent plasticizers, where the addition of a polypropylene or similar thermoplastic polymer having a desired melt flow index can be used to dramatically improve flow characteristics. In addition, the starch-based material exhibits excellent responsiveness to extrusion temperature, in that the material exhibits significantly decreased viscosity as extrusion temperature increases. It is surprising that it is possible to achieve sufficient melt strength and other rheological characteristics needed for directional alignment article manufacturing, where a significant fraction of such a starch-based component is present in the formulation.

It is surprising that such “handles” or “levers” are sufficient to achieve sufficient melt strength, extensional viscosity, critical shear stress and other characteristics needed to effectively extrude a directionally aligned film, sheet, or similar article, where the composition includes a substantial fraction of the starch-based polymeric material. This is possible, even where no strain hardening additives are specifically added to the composition. For example, Applicant has further observed that the presently contemplated starch-based polymeric materials employed appear to be strain hardening on their own, rather than strain thinning, as other thermoplastic starch materials appear to be.

Examples of suitable starch-based materials are available from BioLogiQ, under the tradename “NuPlastiQ”, particularly those having very high molecular weight as described herein. Some characteristics of NuPlastiQ materials (particularly NuPlastiQ GP and NuPlastiQ CG) are described in various of Applicant's other U.S. applications, (e.g., U.S. application Ser. No. 16/925,705 (21132.27.1.1), already incorporated by reference in its entirety herein). Many characteristics of the presently described high molecular weight starch-based materials may be similar to those previously described relative to NuPlastiQ GP and NuPlastiQ CG, which did not necessarily have such high molecular weight. Other starch-based polymers may also be suitable for use, e.g., where such material may exhibit at least some of the other key characteristics described herein, that enable extrusion and directional alignment of such material.

At least in the case of using any of various NuPlastiQ grades as the starch-based material, biodegradability of the resulting blend is increased and/or accelerated. For example, in polymer/NuPlastiQ blends including polymers heretofore considered non-biodegradable, such as polypropylene or polyethylene, a substantial portion or all of the carbon atoms (including those of the PP and PE) in the blended product can be far more quickly converted by microorganisms into CO₂ and/or CH₄. In other words, NuPlastiQ can render polypropylene and polyethylene biodegradable when blended therewith, in a homogenous mixture, where the NuPlastiQ is intimately dispersed in the polypropylene or polyethylene. Additionally, when blending with polymers heretofore considered to be compostable or biodegradable, such as PLA or others (e.g., PBAT, PBS, PCL, PHA or the like), the rate and/or extent of biodegradation of such other polymer may be further increased by addition of the NuPlastiQ starch-based material under any given conditions. The rate of microbial conversion depends on several factors such as thickness of the structure, other form of the article (e.g., ground powder vs. larger contiguous piece), number of microorganisms, type of microorganisms, environmental conditions (e.g., pH, moisture, temperature, etc.), ratio of NuPlastiQ starch-based material to the other polymer(s) in the product, type of plastics in the blend, the strength of the carbon bonds in the plastic, etc.

The present embodiments thus allow for formation of directionally aligned extruded products from starch materials by blending the starch material (e.g., which has viscosity characteristics that may be at least an order of magnitude greater than starches previously contemplated for similar use) with a thermoplastic diluent polymer material, in a manner so as to ensure that the desired rheological properties are obtained (e.g., maintaining shear stress below the critical threshold, while providing sufficient melt strength and extensional viscosity), when processing such a composition through a extrusion die or orifice, and subsequently stretching the extruded polymer melt, so as to align the molecular chains in the MD direction, the CD direction, or both. Such can be achieved even at commercial line shear rates and speeds (e.g., up to 500 m/min, or up to perhaps even 1000 m/min), allowing such a starch composition to advantageously be incorporated into such extruded articles otherwise formed from a conventional thermoplastic material, thus improving the sustainability characteristics of such extruded articles or webs.

In addition to providing such formulations with increased sustainable biocontent, the present embodiments are also directed to such products (e.g., compositions, extruded directionally aligned articles, webs formed therefrom, as well as any articles incorporating such aligned structures etc.) that may provide one or more mechanical or physical advantages associated with inclusion of the starch-based polymeric material within the composition. For example, incorporation of the presently contemplated starch-based materials can actually increase the critical shear stress threshold characteristics of the thermoplastic polymeric material with which it is compounded or otherwise blended, e.g., providing a manufacturer additional flexibility in the parameters at which a production process is run, using conventional resins. For example, typical polypropylene compositions exhibit a critical shear stress of about 100 kPa, above which threshold melt flow instability occurs, which renders it impossible to effectively extrude or otherwise form a desired article under such conditions, above the critical shear stress. The present starch-based polymeric materials may actually increase the applicable critical shear stress threshold, allowing the composition to be effectively processed at higher shear stresses, e.g., up to about 125 kPa, 150 kPa or even 200 kPa, depending on how much of the starch-based material is added to the formulation. Such is a distinct advantage, potentially allowing production of thinner films, faster line speeds, etc.

### III. Exemplary Articles and Methods

The present blends and processes can include one or more thermoplastic polymeric materials having a melt-flow index configured to act as a diluent to the starch-based polymeric material. Polypropylene is an example of such a material in the production of BOPP, MDO polypropylene, or CDO polypropylene, although other thermoplastic polymers may also be suitable for use (e.g., polyethylene in production of BOPE, or MDO or CDO polyethylene). By way of example, the selected thermoplastic polymer may have a melt flow index (MFI) of at least 1, at least 2, or at least 3, for example, from 1 to 10, or from 1 to 5 g/10 min. In an embodiment, different thermoplastic polymers with different MFI values may be blended with the starch-based polymeric material. For example, one thermoplastic polymer may have an MFI of 10 g/10 min or less, or 5 g/10 min or less. Another thermoplastic polymer may have an MFI of at least 10 g/10 min, at least 20 g/10 min, or at least 35 g/10 min (e.g., 10 to 100 g/10 min, such as 10 to 50 g/10 min, or about 35 g/10 min). As noted, in an embodiment, more than one such diluent material may be used, e.g., such as a thermoplastic polymeric material having a melt flow index of 3 g/10 min, and another having a melt flow index of 35 g/10 min.

While polypropylene is an example of one particularly suitable material, other thermoplastic materials may also be suitable for use, e.g., including, but not limited to polyethylene, other polyolefins, polyesters such as PLA, PBAT or the like. In an embodiment, the thermoplastic materials may have a MFI value greater than that of the starch-based polymeric material. In an embodiment, the MFI value for the thermoplastic material(s) may be from 1 to 500 g/10 min, from 2 to 200 g/10 min, from 2 to 100 g/10 min, or from 2 to 50 g/10 min. Such MFI values are typically noted in units of g/10 min, under standardized conditions (e.g., ASTM D-1238 or other relevant standard). Such values may typically be higher than the melt index of the starch-based polymer, under the same conditions. By way of example, the MI for an exemplary NuPlastiQ material as shown in Table 1 is 6 g/10 min at 170° C. under a 21.6 kg load. Such materials are very viscous, exhibiting little flow under standardized testing conditions. As a practical matter, it is very difficult to measure the MFI at a standard temperature of 190° C. using the standard 2.16 kg weight because the value is quite low, and because a significant fraction of any such flow may be due to degradation of the NuPlastiQ material under such conditions, so that any measured values can be quite inconsistent. Because the NuPlastiQ material is stable, and consistent, accurate measurement is possible at 170° C. under a higher load of 21.6 kg, this is the reported conditions for the value shown in Table 1.

The thermoplastic material used as a diluent to improve the rheological characteristics of the starch-based material may be sourced from conventional petrochemical “fossil fuel” sources, or from so-called “green” or renewable sources (e.g., bioPE, bioPET, PLA, other polyesters, and the like). Petrochemical fossil fuel vs. renewable sources may be differentiated from one another using various analytical methods, e.g., one of which can involve determining the ratio of C¹⁴ vs. C¹² within the materials. By way of example, petrochemical fossil fuel sources contain no C¹⁴ content, while materials (even the same material, such as “green” PE vs. conventional fossil fuel PE) sourced from renewable or sustainable materials (renewable and sustainable are used interchangeably herein) will exhibit an elevated content of C¹⁴ (e.g., perhaps 1 in 1 trillion carbon atoms). Of course other analytical methods exist for identifying and differentiating between two such differently sourced materials (fossil fuel derived vs. renewably sourced). Those of ordinary skill within the art will appreciate that renewable materials are derived from starting materials which can be replenished generation after generation (e.g., renewed within about 100 years or less), rather than fossil fuel sources (which take at least tens of thousands of years to develop). Examples of such renewable source materials include various plant crops, such as various plant starches, sugarcane, corn, or other plant products. The starch-based polymeric materials and the thermoplastic diluent materials having desired MFI characteristics can be provided in any desired form, such as pellets, powders, curdles, slurry, and/or liquids.

The present compositions may be used to form extruded articles in which the molecular chains are directionally aligned, for use in any desired article through any conceivable process. Examples of such processes include extruded films, nonwoven webs, sheets, and the like, the details of which will be apparent to those of skill in the art. As the composition includes the starch-based polymeric material and one or more thermoplastic polymeric materials having specifically desired melt flow index characteristics, such components can be compounded (e.g., with or without a compatibilizer) together before extrusion. By way of example, the materials may all be compounded together in advance, and then fed into the extruder.

In an embodiment, the starch-based material can be provided in the form of a masterbatch, which masterbatch already includes a thermoplastic diluent material and optionally a compatibilizer. The masterbatch may be blended with additional thermoplastic diluent material in the extruder, in the same process during which extrusion occurs. For example, the masterbatch may include the starch-based polymeric material, the compatibilizer, and a first thermoplastic diluent material with a desired MFI value. Such a masterbatch can then be further blended with another or additional thermoplastic polymer diluent material (e.g., having a relatively low MFI, such as 5 g/10 min or less) just before extrusion of the film or sheet. Once extruded, the polymer melt film or sheet is then stretched to align the molecular chains, to provide the desired directional alignment.

It will be apparent that numerous possibilities exist for such blending or compounding. Where final blending or compounding occurs in the extrusion process, for example, one or more of the thermoplastic polymers with specifically selected melt flow index characteristics and the starch-based material can be fed into an extruder (e.g., into one or more hoppers thereof). The different materials can be fed into the extruder into the same chamber, into different chambers, at approximately the same time (e.g., through the same hopper), or at different times (e.g., through different hoppers, one being introduced into the extruder earlier along the screw than the other), etc. It will be apparent that numerous possibilities exist for such processing.

It will be apparent that many blending possibilities are possible. In an embodiment, any provided masterbatch including the starch-based material may already include at least a portion of the one or more thermoplastic polymers with particularly selected melt flow index values. For example, where the thermoplastic polymers include two or more different polymers, with different melt flow index values (e.g., 3 g/10 min and 35 g/10 min, or other values), the masterbatch may already include at least one such thermoplastic polymer already compounded with the starch-based material. The compatibilizer may also typically be present in such a masterbatch. By way of example, where the final composition used to extrude film or sheet is intended to include 25% by weight of the starch-based polymer, 4% compatibilizer, and 71% of the thermoplastic polymers with particular melt flow index values, the masterbatch may include 50% by weight of the starch-based material, with 8% compatibilizer, and with 42% of one or more of the thermoplastic polymers. By way of example, the masterbatch may then be blended 1:1 (or other blending ratio) with additional thermoplastic polymer(s) with specifically desired melt flow index value(s) to achieve the final composition from which the film or sheet is to be extruded.

An important characteristic of the present compositions can be that the selected starch-based material have a high molecular weight, e.g., higher than many starch-based materials used in the polymer industry more generally. For example, previous work in incorporation of starch-based materials into some processes (e.g., fiber spinning) has focused on efforts to increase the amylose content of the starch-based material (e.g., through enzymatic debranching), or to otherwise reduce the molecular weight of the starch-based material so that it has rheological characteristics that might allow the composition to be more easily processed. Even with such modifications, the rheological characteristics of such blends may still be incompatible with manufacturing processes run at commercial line speeds (e.g., at least 500 m/min, or at least 1000 m/min), at commercial shear rates. Such modifications may also actually decrease melt strength of the polymer melt, which is of course undesirable.

In addition, the compositions described in such previous attempts invariably include significant water content, which can be important. While it can be difficult to remove such residual water content (as much of it is present as bound water, bound to the starch molecules) in conventional starch-based materials, the residual presence of water can undesirably affect various material properties. In at least some embodiments as contemplated herein, the water content of the starch-based material is minimal, e.g., no more than 2%, or no more than 1.5%, even including any bound water (e.g., typical native starches include at least 5% bound water).

Using the same reactive extrusion process through which commercially available grades of NuPlastiQ have been previously available, Applicant has now prepared very high molecular weight starch-based polymeric materials, which can be incorporated into compositions suitable for extrusion and directional alignment of the molecular chains within the extruded film or sheet. Such materials as specially prepared as described herein may differ in some respects from those otherwise previously commercially available from BiologiQ, under the tradename NuPlastiQ (e.g., NuPlastiQ GP and NuPlastiQ CG), e.g., in molecular weight, in the starting starch material(s) from which they are formed, proportions thereof, etc. In any case, the presently described and contemplated starch-based polymeric materials may exhibit significantly higher molecular weight values than other starch-based materials suggested to be spinnable. As noted, Applicant is not even aware of any significant commercial work to develop starch-containing formulations that would be suitable for use in directional alignment extrusion processes.

Other than Applicant's efforts, Applicant is not aware of any significant commercial attempts to incorporate starch-based polymeric materials into extruded products with molecular chains that are directionally aligned. Even in the somewhat related field of fiber spinning (where draw or shear rates can be high), other than Applicant's own efforts, Applicant is not aware of any large scale commercial spinning of fibers (much less directional alignment extrusion) from a composition including a significant fraction (e.g., at least 1%, at least 2%, at least 3%, at least 5%, at least 10%, at least 15%, or at least 20%) of a starch-based polymeric material having high molecular weight. Such is not surprising, given that viscosity rises exponentially with molecular weight, and compositions with very high viscosity are poor candidates for such processing. Previous attempts described in the literature to spin thin fibers from compositions including a starch-based material have only succeeded in spinning such fibers where the starch-based component has a molecular weight (weight average molecular weight) of up to about 1 million, sometimes up to perhaps as much as 2 million. For example, Star Dri-100, used in many such examples in the literature, has a molecular weight of only about 21,000, as measured using the same gel permeation chromatography methods used for molecular weight measurements for the starch-based polymeric materials described herein. For example, at least one of the present inventors believed it to be impossible that such starch-based compositions could be made suitable for use in processes involving extrusion and directional alignment of the molecular chains. The present disclosure describes how to achieve such.

The starch-based material can be formed from one or more starches from one or more plants, such as corn starch, tapioca starch, cassava starch, wheat starch, potato starch, rice starch, sorghum starch, algae starch and the like. In some embodiments, a mixture of different starches may be used, as described in various of Applicant's earlier applications, already incorporated by reference. In other embodiments, only a single starch may be used in forming the starch-based material. The starch-based material is typically formed with a plasticizer in addition to the starch. In an embodiment, the materials from which the starch-based polymeric material is formed may consist essentially of the starch and plasticizer. Additional components such as an odor reducing agent, or other adjuncts may optionally be included. Use of an odor reducing agent (e.g., vanillin) is described in Applicant's U.S. Pat. No. 10,920,044 (21132.12.1), herein incorporated by reference in its entirety. Once the starch-based polymeric material is formed from the starch and plasticizer, a compatibilizer or other adjuncts may be compounded into a masterbatch including the starch-based polymeric material and a thermoplastic diluent polymer (e.g., polypropylene with a selected MFI value).

The starch-based material can be formed from mostly starch. For example, at least 65%, at least 70%, at least 75%, or at least 80% by weight of the starch-based material may be attributable to the one or more starches. In an embodiment, from 65% to 90% by weight of the finished starch-based material may be attributed to the one or more starches. Other than negligible water content (e.g., no more than 1.5-2%), essentially the balance of the finished starch-based material may be or attributed to the plasticizer (e.g., glycerin). Where an odor reducing agent is included, the odor reducing agent is typically included in very small amounts (e.g., less than 1%, often far less than 0.1%, such as 1 to 100, or 1 to 10 ppm). The percentages above may represent starch percentage relative to the starting materials from which the starch-based material is formed, or that fraction of the finished starch-based material that is derived from or attributable to the starch (e.g., at least 65% of the starch-based material may be attributed to (formed from) the starch(es) as a starting material). Substantially the remainder may be attributable to the plasticizer.

By way of example, materials from which the starch-based material is formed can include at least 12%, at least 15%, at least 18%, at least 20%, at least 22%, no greater than 35%, no greater than 32%, no greater than 30%, no greater than 28%, or no greater than 25% by weight of a plasticizer. Such percentages may also represent that fraction of the finished starch-based material that is derived from or attributable to the plasticizer.

Exemplary plasticizers include, but are not limited to glycerin, polyethylene glycol, sorbitol, polyhydric alcohol plasticizers, hydrogen bond forming organic compounds which do not have a hydroxyl group, anhydrides of sugar alcohols, animal proteins, vegetable proteins, aliphatic acids, phthalate esters, dimethyl and diethylsuccinate and related esters, glycerol triacetate, glycerol mono and diacetates, glycerol mono, di, and tripropionates, butanoates, stearates, lactic acid esters, citric acid esters, adipic acid esters, stearic acid esters, oleic acid esters, other acid esters, or combinations thereof. Glycerin may work particularly well.

The finished starch-based material may include no greater than 5%, no greater than 4%, no greater than 3%, no greater than 2%, no greater than 1.5%, no greater than 1.4%, no greater than 1.3%, no greater than 1.2%, no greater than 1.1%, or no greater than 1% by weight water, including bound water. By way of example, other starch-based materials described for use in spinning include substantial bound water (e.g., 5-16%), far higher than the water content typically present in the presently contemplated starch-based materials. Furthermore, while lower water content may be described in some references describing starch-based polymeric materials more generally, no effort has been made to modify such materials to be suitable for spinning or directional alignment extrusion, and because of the very demanding rheological specifications required for such, it is not a simple operation to simply swap one such material for another, particularly where those materials that have been specifically formed to be spinnable include significant water content.

Additional details relative to fractions of starch and glycerin or other plasticizers used in forming starch-based materials are described in Applicant's other patent applications, already incorporated herein by reference. Physical characteristics for NuPlastiQ GP are shown in Table 1 below. The properties for the described starch-based polymers used herein, for directional alignment extrusion are believed to be similar to those shown in the table, although of course, others may differ in some instances, e.g., due to differences in molecular weight, etc. By way of example, properties of density, glass transition temperature, tensile strength, Young's modulus, elongation at break, dart impact, and water content may be representative of the starch-based polymeric materials contemplated for use in the present embodiments. Any of such characteristics may be measured by any of various ASTM or other standards, as will be appreciated by those of skill in the art. Some characteristics may vary somewhat (e.g., ±25%, or ±10%) from values shown in Table 1.

TABLE 1

| | | NuPlastiQ GP | |
|---|---|---|---|
| | | NOMINAL | |
| PROPERTY | TEST METHOD | VALUE | |
| Density | ASTM D-792 | 1.40 | g/cm³ |

THERMAL PROPERTIES

| Melt Flow Index | ASTM D-1238 | 6 g/10 min | |
|---|---|---|---|
| 170° C./21.6 kg | | | |
| Glass Transition | ASTM E-1356 | 50-70° | C. |
| Temperature | | | |

MECHANICAL PROPERTIES

| Tensile Strength @ | ASTM D-638 | >30 | MPa |
|---|---|---|---|
| Yield | | | |
| Tensile Strength @ | ASTM D-638 | >30 | MPa |
| Break | | | |
| Young's Modulus | ASTM D-638 | 1.5 | GPa |
| Elongation at Break | ASTM D-638 | <10% | |
| Impact Resistance | ASTM D-5628 | 3.5 | kg |
| (Dart) | | | |

ADDITIONAL PROPERTIES

| | | |
|---|---|---|
| Water Content | ASTM D-6980 | ≤1.5% |

Weight average molecular weight of the starch-based polymeric material may be relatively high, as described herein, e.g., greater than 2 million, greater than 3 million, greater than 4 million, greater than 5 million, such as from 3 to 20 million, 5 to 18 million, or 5 to 16 million. Such values may be determined through any of various suitable size exclusion chromatography methods, e.g., GPC and/or GFC. The values in the examples herein were determined through size extrusion chromatography with multi-angle light scattering (MALS) and refractive index (RI) detection. In any case, such molecular weight values are significantly higher than starch-based materials contemplated for similar uses. The starch from which the starch-based polymeric material is made may similarly have a very high molecular weight as described herein. That said, it will be appreciated that in other embodiments, it may be possible to use a starting starch or finished starch-based polymeric material having lower weight average molecular weight, e.g., less than 2 million, or perhaps even less than 1 million. Viscosity is strongly related to molecular weight. Due to high molecular weight, the presently contemplated starch-based materials also exhibit viscosity characteristics that are significantly higher than starch-based materials used in similar processes. Applicant is not aware of any significant commercialization of starch-based polymeric material in a directional alignment extrusion process, particularly where the starch-based polymeric material is of such high molecular weight. Such processes require very particular rheology characteristics as to critical shear stress, melt strength, and the like. For example, the zero shear viscosity, even at a given process temperature (e.g., 170-195° C.) or other relevant temperature may be at least an order magnitude higher than previously contemplated starch-based materials.

While some of the properties may be similar to other thermoplastic starch materials, other properties may differ markedly from typical starch-based materials. For example, the density of NuPlastiQ materials is particularly high, e.g., greater than 1 g/cm³, at least 1.1 g/cm³, at least 1.2 g/cm³, or at least 1.25 g/cm³, (e.g., the 1.4 g/cm³, as shown above in Table 1). Various of the other properties may also differ substantially from superficially similar appearing starch-based polymeric materials. The NuPlastiQ materials have a low water content, as described. As this material absorbs moisture, it exhibits plastic behavior and becomes flexible. When removed from a humid environment, the material dries out and becomes stiff again (e.g., again exhibiting less than about 1.5% water content). Any moisture present in NuPlastiQ (e.g., in pellet form) may be released in the form of steam during processing. As a result, extruded films, sheet, webs or other articles produced from the contemplated starch-based materials blended with the thermoplastic material(s) selected for particular melt flow index, melt strength, or other values may exhibit even lower water content, as the thermoplastic diluent material typically will include no or negligible water, and substantially all of the water in the starch-based polymeric material may typically be released during manufacture of a desired article.

Low water content in any starch-based material can be important, as significant water content can interfere with the ability to process the composition at elevated temperatures. Applicant has observed relatively hydrophobic characteristics for films of blends including NuPlastiQ (e.g., as determined by dyne pen testing), as described in various applications already incorporated by reference, although far more hydrophilic characteristics have been observed in some nonwoven forms. Thus, it may be possible to tailor the hydrophobicity/hydrophilicity characteristics of a given product to be as desired. Of course, various characteristics can also be provided by providing structures with multi-component, laminate, or other non-homogenous characteristics, to provide desired characteristics within desired portions of a given article.

Low water content is not achieved in the NuPlastiQ material through esterification or etherification, as is common in some other TPS materials that may include relatively low water content. Such esterification or similar modifications can be expensive and complex to perform. Furthermore, the NuPlastiQ materials that are exemplary of the starch-based materials employable herein have been mechanically, physically or chemically reacted and/or altered, compared to the starting starch and glycerin materials. For example, the starch-based material may be the product of a reactive extrusion process, e.g., under pressure, at extrusion temperatures as described herein. The finished starch-based material may not be recognized as a simple mixture including native starch and glycerin, but has undergone chemical and/or physical changes, including changes in molecular weight relative to the starting starch material. The low water content achievable in the starch-based material may be due at least in part to the physical or chemical alteration of the starch and plasticizer materials into a starch-based thermoplastic polymer, which does not retain water as may be the case with native starch, or other conventional thermoplastic starch materials. In addition, the NuPlastiQ materials resist recrystallization or retrogradation, common with many other thermoplastic starches. For normal thermoplastic starches, they exhibit a tendency to “retrograde” which is exhibited as they recrystallize over time from a relatively amorphous state back into a more crystalline state—the natural state of native starch powder. Most thermoplastic starches recrystallize over time because the thermoplastic starch structure is not sufficiently stabilized to limit the mobility of starch molecules, plasticizer migration and evaporation over time. In contrast, NuPlastiQ does not retrograde or recrystallize to any significant degree. While some starch-based polymeric materials are enzymatically debranched (e.g., increasing the amylose fraction, decreasing the amylopectin fraction), decreasing the molecular weight thereof, the presently described starch-based polymeric materials are not typically enzymatically treated, for debranching, or for other purposes, although they may exhibit decreased (or increased) molecular weight as compared to the starting starch material, and/or increased amylose content. In any case, the resulting molecular weight of the starch-based polymeric material can be relatively high, as described herein.

In addition to the starch-based material being thermoplastic, the high molecular weight NuPlastiQ material may also be solid at ambient temperature, but flows as a liquid when heat, pressure and/or friction are applied. Advantageously, pellets of high molecular weight NuPlastiQ can be used generally the same as any typical plastic resin pellets in standard plastic production processes, including directional alignment extrusion processes, when blended with a diluent thermoplastic polymer as described herein to achieve the needed rheological characteristics for such extrusion and alignment, as described herein.

The starch-based polymeric material may also be strain hardening itself, without the addition of strain hardening components to achieve such. This apparent strain-hardening characteristic of the present NuPlastiQ starch-based materials is in contrast to the characteristics of other starch-based polymeric materials, which seem to exhibit strain thinning characteristics, exacerbating attempts to extrude them in a way that would include directional alignment. For example, a strain hardening material will actually increase in viscosity (flow resistance) over time, even under constant applied shear conditions, while a strain thinning material performs oppositely (decreased viscosity over time). Strain hardening can play an important role in the ability to effectively directionally align the molecular chains, as under such conditions if the elongational or extensional viscosity is insufficient, the material will break, rather than exhibiting sufficient resistance (melt strength and/or elongational viscosity) to maintain the structure during untangling and alignment of the molecular chains. The present starch-based materials may themselves exhibit such strain hardening, without any need to add a separate strain hardening adjunct to the formulation. This feature of strain hardening is important and valuable.

The present starch-based materials appear to exhibit strain hardening characteristics, which greatly aids in the ability to maintain sufficient melt strength and to stretch such starch-based materials so as to directionally align both the polypropylene or other polymer molecules, and the starch-based material molecules. This characteristic is one of those that appears to be important in allowing such processing to occur, even with such a very high molecular weight starch based material.

The starch-based material may be non-toxic, made using raw materials that are all edible. The resulting starch-based material may be water resistant, even hydrophobic. As described above, articles comprising the starch-based material may still have a surface wettability that is relatively low (e.g., 34 dynes/cm or less), similar to many typical polyolefins (e.g., polyethylene or polypropylene), although it may also be possible to achieve a far more hydrophilic surface, as described in U.S. application Ser. No. 17/327,536 (21132.31.1), U.S. application Ser. No. 17/327,577 (21132.31.2), and U.S. application Ser. No. 17/327,590, already incorporated by reference.

In addition, the NuPlastiQ or other starch-based material may be stable, in that it may not exhibit any significant retro-gradation, even if left in relatively high humidity conditions. In contrast, most thermoplastic starches will recrystallize over time because some parameters of the thermoplastic starch structure are not sufficiently stabilized to limit the mobility of starch molecules, plasticizer migration and evaporation over time. Such recrystallization of starch molecules, is referred to as “retrogradation,” which is exhibited by a deterioration of the mechanical properties of most thermoplastic starch materials, e.g., resulting in a brittle material. Of course, products made with NuPlastiQ or a similar starch-based material may also exhibit such stable characteristics. If NuPlastiQ is stored in humid conditions, the excess absorbed water can simply be evaporated away, and once the water content is no more than about 1%, it can be used in forming extruded directionally aligned films, sheet, or other articles.

Similar to paper, NuPlastiQ does not typically undergo biodegradation under typical storage conditions, even in relatively humid conditions, as the other conditions typical of an anaerobic digester, industrial compost or similar disposal environment containing the particular needed microorganisms are not present. Of course, where such conditions are present, not only does NuPlastiQ biodegrade, but significant portions of otherwise non-biodegradable plastic materials blended therewith (e.g., polypropylene) surprisingly have been shown to biodegrade as well. Extensive evidence of such is described in Applicant's other applications, already incorporated herein by reference. Inclusion of as little as 1% NuPlastiQ is sufficient to trigger significant biodegradation of the various components included in the blend. Where a component included in the blend is already biodegradable to some degree, NuPlastiQ tends to increase the rate and/or extent of biodegradability for such component.

In some embodiments, a starch-based material could be provided in a masterbatch formulation that may include the starch-based material, one or more other plastic materials (e.g., one or more thermoplastic materials selected specifically for their melt flow index or other characteristics), and optionally a compatibilizer. Such a masterbatch may include an elevated concentration of the starch-based material, e.g., so as to be specifically configured for mixing with pellets, powders, etc. of the same or another thermoplastic material compared to that already included in the masterbatch, at the time of further processing where directionally aligned extruded films or sheets are to be formed, effectively dropping the concentration of the starch-based material down to the desired final value (e.g., the masterbatch may be at about 50% starch-based material, while a finished article may include 20-30%). Of course, other values are also possible. Any conceivable ratios may be used in mixing such different pellets, powders, etc., depending on the desired percentage of starch-based material and/or compatibilizer and/or higher melt flow index thermoplastic material in the finished directionally aligned extruded film or sheet being formed.

In an embodiment, the starch-based material may be substantially amorphous. For example, raw starch powder typically has an approximately 50% crystalline structure. Many thermoplastic starch materials similarly have relatively high crystallinity. By way of example, the starch-based material used as described herein may have a crystallinity of less than about 40%, less than about 35%, less than about 30%, less than about 25%, less than about 20%, less than about 15%, less than about 10%, less than 9%, less than about 8%, less than 7%, less than about 6%, less than about 5%, or less than about 3%. Any suitable test mechanism for determining crystallinity may be used, e.g., including but not limited to FTIR analysis, X-ray diffraction methods, and symmetrical reflection and transmission techniques. Various suitable test methods will be apparent to those of skill in the art.

As described herein, blending of the starch-based material with a plastic material (e.g., the thermoplastic material having a higher melt flow index, selected to dilute and further plasticize the starch-based material) can result in not just the starch-based material being rapidly biodegradable, but the non-biodegradable thermoplastic materials included in the blend actually become significantly more rapidly biodegradable as well (even where the high melt flow index thermoplastic material alone is not significantly otherwise biodegradable). Such results of course do not occur within previously reported blends. Such results have been documented when blending at least with NuPlastiQ. It is believed that the highly intimate blending of the starch-based component into the other plastic material, as well as other factors, may allow such to occur. Such differences in biodegradability clearly illustrate that there are significant structural and/or chemical differences in the resulting directionally aligned extruded films, sheets or other articles, as the entire composite structure is now capable of being more rapidly biodegraded. The materials may also exhibit enhancements to other physical properties, such as strength characteristics.

Without being bound to any particular theory, it is believed that the starch-based material (e.g., particularly in the case of NuPlastiQ), may interrupt the hygroscopic barrier characteristics of the polypropylene or other non-biodegradable plastic materials in a way that intimately blends the two together, and allows microorganisms to degrade the arrangements and linkages of otherwise non-biodegradable plastic molecules of the blend, along with the highly intimately dispersed starch-based material. The highly intimate dispersion of very small particles or domains of the starch-based component may also be important in any such mechanism, as microbes quickly encounter the other polymeric material, because the starch particles or domains are so well dispersed. Because of such dispersion, the microbes may continue “munching” on the polymeric material after consuming a given starch-based particle, until they encounter the next adjacent starch-based particle (which may be more easily digested).

In fact, PiFM analysis of such blends shows that the typical separate and relatively pure polyolefin “sea” surrounding starch domain “islands” does not form, but there is starch material even within the polyolefin “sea”, and polyolefin within the starch “islands”, so that separate, relatively pure domains as exist in conventional starch/polyolefin blends do not form. Additional details relative to such analysis is found in the prosecution history of Applicant's application Ser. No. 15/481,823 (now U.S. Pat. No. 10,919,203), the prosecution history of which is herein incorporated by reference. Blends of the NuPlastiQ with another thermoplastic resin material exhibit a substantial lack of “sea-island” features, in contrast to conventional starches or starch-based materials. Such does not mean that the blend cannot exhibit some heterogeneous morphology characteristics, but rather, that there is starch material even within any polyolefin “sea”, and polyolefin within the starch “islands”, so that separate, relatively pure domains as exist in conventional starch/polyolefin blends do not form. Such morphology is also believed to occur with other plastics (e.g., polyesters, polystyrene and others) when blended with NuPlastiQ starch-based polymeric materials. By way of theory, the long polymer chains of polypropylene or other non-biodegradable plastic material may be more easily broken in environments that are active in bacteria and microorganisms, when homogenously blended with the presently contemplated starch-based materials. Subsequently, the microorganisms that exist naturally in a disposal environment (e.g., in an anaerobic digester or industrial compost) can consume the remaining smaller molecules so that they are converted back into natural base mineralized components (such as CO₂, CH₄, and H₂O). Even where such articles may be disposed of in an undesirable environment (e.g., litter), biodegradation of non-starch components may be achieved much faster with NuPlastiQ present in the blend. In at least the case of NuPlastiQ, and in testing conducted to date in the form of films, the NuPlastiQ does not seem to promote fragmentation of the macro structure into small pieces, but the articles as formed tend to biodegrade, while appearing to remain substantially intact for much of such process. It is believed that this biodegradation effect is further enhanced, and more consistently achieved, when the starch-based component is intimately and homogenously dispersed, with very small domain sizes, e.g., as described in Applicant's U.S. application Ser. No. 16/925,747 (21132.30.1) and Ser. No. 16/925,705 (21132.27.1.1), each of which is herein incorporated by reference in its entirety. While some prior art references may describe blend morphologies where a starch or thermoplastic starch phase is in a discontinuous (or continuous) phase, and the polyolefin or other plastic phase is in the other phase (e.g., a continuous plastic phase, with a discontinuous starch phase, or vice versa), the NuPlastiQ blends may not be so structured, but include starch-based polymeric material in any polyolefin or other plastic resin phase, and the polyolefin or other plastic resin material in the starch-based polymeric material phase.

In any case, carbon isotope testing commissioned by Applicant as described in the prosecution history of Applicant's U.S. application Ser. No. 15/481,823 (21132.2) has also confirmed that the NuPlastiQ starch-based material degrades at approximately the same rate as the other thermoplastic material with which it is blended, during biodegradation of a given article, such that the ratio of NuPlastiQ (which is rich in C¹⁴) to other thermoplastic material (in which carbon atoms thereof consist essentially of C¹², if sourced from fossil fuel sources) in the blend remains substantially the same, as the blend biodegrades. In other words, both materials are microbially assimilated at approximately equal rates, according to their concentration in the blend. Even where the NuPlastiQ is blended with a thermoplastic resin also rich in C¹⁴ (e.g., such as bioPE), both materials tend to biodegrade at rates consistent with their concentration in the original blend, such that the ratio of the starch-based polymeric material to the other thermoplastic resin material in the blend remains substantially the same, both before and after biodegradation of the blend has occurred. Such “green/green” blends (blends of a starch-based polymeric material with a biopolyethylene or similar “green” thermoplastic resin) are described in Applicant's U.S. application Ser. No. 15/836,555 (21132.4.1).

Biodegradable plastics are converted into natural base component compounds such as carbon dioxide, methane, water, inorganic compounds, or biomass via microbial assimilation (e.g., the enzymatic action of microorganisms on the plastic molecules). Such process is sometimes referred to as “mineralization”.

Plastics made from petrochemical feedstocks generally begin life as monomers (e.g., single small molecules that can react chemically with other small molecules). When monomers are joined together, they become polymers (“many parts”), and may be known as plastics. Before being joined together, many monomers are readily biodegradable, although after being linked together through polymerization, the molecules become so large and joined in such arrangements and linkages that microbial assimilation by microorganisms is not practical within any reasonable time frame, in most instances, for numerous materials (e.g., including particularly polyethylene and polypropylene). However, the high molecular weight NuPlastiQ starch-based compositions described in the present invention can impart increased biodegradability to other non-plant-based polymers.

Polyolefins such as rigid forms of polyethylene and polypropylene have a high degree of crystallinity and are made by converting monomer molecules (whether petroleum derived or derived from ethanol or other small building block molecules derived from plant sources) into long chain polymers. The bonds created when connecting the monomers to form long polymer chains are strong and difficult to break. Extruded articles formed from such polymeric materials (e.g., polyethylene and polypropylene) are not biodegradable as defined herein, and have significant strength. Of course, there are now available some polymers which can be consumed through microbial assimilation, under certain conditions, and which can be made to be suitable for use in directional alignment extrusion processes, (e.g., PLA can be industrially compostable under ASTM D-5338 or ASTM D-6400, and some PLAs can be so processed), although such materials are significantly more expensive than polyethylene or polypropylene. Even where a given article is formed from a blend of conventional non-biodegradable plastic material and the conventional thermoplastic starch “TPS” materials which could conceivably be suitable for directional alignment extrusion, any non-biodegradable plastic component in such formulations does not acquire significant biodegradability characteristics as a result of such blending. For example, only the starch portion or other recognized compostable resin components (e.g., PLA) of the blend are capable of microbial assimilation, where access to such components is not blocked or occluded by a non-biodegradable matrix, which may prevent access to portions of some such components, (e.g., as may occur where the blend is of a morphology including a continuous non-biodegradable phase that encapsulates a biodegradable or compostable phase).

In addition, the strength of such existing blended materials is typically reduced as a result of inclusion of the TPS material, particularly at elevated starch loading levels (e.g., 15% or more, 20% or more). For example, numerous references of simple non-directionally aligned film structures exhibit such. Of course such blends are not suitable for directional alignment extrusion, as they do not provide the necessary rheological characteristics. Applicant's starch-based materials may actually serve to increase the strength of the blend, as compared to the thermoplastic material with which it is being blended, in some instances (e.g., with certain grades of polyethylene).

In other words, the starch-based material (such as NuPlastiQ) may have relatively high elastic modulus (stiffness, or strength) characteristics, as compared to other superficially similar appearing starch-based materials, and as compared to many thermoplastic materials with which it may be blended. Because of its high elastic modulus, and the fact that it is not simply present as a filler, but is intimately blended and/or bonded with the other components, it may serve to strengthen a composite blend, rather than weakening it. As a result, extruded articles formed from the present formulations may be stronger than if they were formed purely from the thermoplastic material included in such blends. For example, the contemplated starch-based material may form strong intermolecular bonds with the other materials in the blend, rather than simply being present as a filler, which typically weakens a given blend. For example, the starch-based material can have a Young's modulus (e.g., about 1.5-2 GPa) and/or tensile strength value (e.g., >30 MPa), which values may be higher than the thermoplastic polymer with which it is being blended.

While blending Applicant's NuPlastiQ with another polymer can result in increased strength, it will be appreciated that NuPlastiQ can also be blended with various specific polymers, which may already exhibit significantly high strength characteristics, where the blending may not result in an increase in strength, or may even decrease the strength of the blend, by comparison. Such embodiments are still within the scope of the present disclosure and invention, e.g., where the molecular weight or other characteristics as described herein are provided, and other benefits (e.g., increased renewable content, biodegradability, or the like), while still providing sufficient strength for a given purpose, may be achieved.

When preparing the blend, mixing of the one or more thermoplastic materials having particular melt flow index characteristics and the one or more starch-based materials can be performed using one or more mixing devices. In a particular implementation, a mechanical mixing device can be used to mix the one or more thermoplastic materials and the one or more starch-based materials. In an implementation, at least a portion of the components of the mixture of the materials can be combined in an apparatus of an extrusion and directional alignment system. In other implementations, at least a portion of the components of the mixture of the materials can be combined before being fed into the apparatus (e.g., compounded into a masterbatch). In a typical scenario, the starch-based material and any compatibilizer may be provided in a masterbatch, with at least one thermoplastic polymer included for its higher melt flow index characteristics. Such masterbatch pellets may then be further blended within the extrusion system with additional thermoplastic polymer, specifically selected for its melt flow index, melt strength, or other characteristics so that upon blending of the two, the formulation has compositional characteristics that provided the necessary rheological characteristics to be able to effectively extrude and stretch the film or sheet, while directionally aligning the molecular chains of the blend components in a given direction. Such can be achieved at commercial line speeds. In addition, due to increased critical shear stress for the formulation as provided by inclusion of the starch-based polymeric materials described herein, increases in line speed may actually be achievable, as the formulation may be able to be processed at such higher speeds and shear ratings while maintaining conditions below the onset of melt flow instability for the formulation. As noted herein, problems associated with onset of melt flow instability will be apparent to those of skill in the art, and include, but are not limited to gross surface irregularities associated with inlet fracture and/or land fracture, draw resonance, and secondary flows, any of which can make product produced under such conditions unusable, or at least undesirable.

The one or more starch-based materials can be present in the mixture of materials in any desired fraction. By way of example, the starch-based material may be included in an amount of at least 0.5%, at least 1%, at least 2%, at least 3%, at least 4%, at least 5%, at least 10%, at least 15%, at least 20%, no greater than 99%, no greater than 95%, no greater than 90%, no greater than 80%, no greater than 70%, no greater than 60%, no greater than 50%, no greater than 40%, from 2% to 60%, from 5% to 40%, from 10% to 40%, from 20% to 35%, from 20% to 30%, by weight of the mixture of materials. Other ranges defined between any end point values taken from the above or elsewhere from the present disclosure are also contemplated. Such additional ranges apply not only to the concentration of starch-based materials, but to any other components, characteristics, or other parameters described herein.

More than one starch-based material, and/or more than one thermoplastic material specifically selected for its melt flow index or other characteristics (e.g., melt strength) may be included in the blend, if desired. Examples of characteristics used to identify an additive or other component for inclusion in the blend may include molecular weight distribution, isotacticity (e.g., isotactic polypropylene), long chain branching, copolymers incorporating polypropylene isomers, and the like.

In at least some of the below examples, at least two thermoplastic materials are included, each exhibiting different melt flow index values. In an embodiment, at least some threshold amount of the starch-based material is included, although it is possible that the article may include another starch-based material that may be of lower weight average molecular weight (e.g., less than 3 million, less than 2 million, or less than 1 million), or have other characteristics that differ from the primary starch-based material. That said, in an embodiment, lower molecular weight starch-based materials may not be intentionally added. Of course, it will be appreciated that starch-based materials exhibit a distribution of molecular weights, and that even a starch-based material exhibiting a high average molecular weight itself may include some fraction of lower molecular weight molecules.

The thermoplastic diluent material(s) with which the starch-based material is blended can be present in the mixture of materials in an amount of at least 1%, at least 2%, at least 3%, at least 4%, at least 5%, at least 10%, at least 15%, at least 20%, at least 25%, at least 30%, at least 35%, at least 40%, at least 45%, at least 50%, no greater than 99%, no greater than 95%, no greater than 90%, no greater than 85%, no greater than 80%, no greater than 75%, more typically from 10% to 90%, from 20% to 85%, from 40% to 80%, or from 60% to 80% by weight of the mixture of materials. Other ranges defined between any end point values taken from the above or elsewhere from the present disclosure are also contemplated. More than one such thermoplastic material (i.e., combinations of such thermoplastics, each with different melt flow index characteristics) may be included in the blend.

By way of example, the blend may include a significant fraction of at least one thermoplastic material selected for its melt flow index of at least 10 g/10 min, at least 20 g/10 min, at least 30 g/10 min, less than 100 g/10 min, less than 80 g/10 min, less than 60 g/10 min, or less than 50 g/10 min such as from 10 to 50 g/10 min (e.g. 35 g/10 min). Other ranges defined between any end point values taken from the above or elsewhere from the present disclosure are also contemplated. For example, such a thermoplastic material may be present in the formulation in an amount of at least 5%, at least 10%, no more than 30%, 25%, or 20%, such as 10-15% of such, along with additional 2^{nd} thermoplastic material having a significantly lower melt flow index (e.g., from 1 to 10 g/10 min, such as 3 g/10 min). Such second thermoplastic material may be present in an amount even greater amount that then first thermoplastic material, e.g., included in an amount of at least 20%, at least 30%, or at least 40%, such as from 20% to 80%, or 25% to 70% by weight of the blend. Other ranges defined between any end point values taken from the above or elsewhere from the present disclosure are also contemplated for the various thermoplastic diluent materials. The examples describe blends, e.g., including 50% to 70% of a polypropylene having an MFI of 3 g/10 min, 5-25% of a polypropylene having an MFI of 35 g/10 min, 1-10% (e.g., 4%) of a maleic anhydride modified polypropylene compatibilizer, and 10-40% (e.g., 25%) of the starch-based polymer. One example included 50% 3 MFI PP, 21% 35 MFI PP, 4% compatibilizer, and 25% starch-based polymer. Another example included 16% of a polypropylene having an MFI of 35 g/10 min, 55% of a polypropylene having an MFI of 3 g/10 min, 4% of a maleic anhydride modified polypropylene compatibilizer, and 25% of the starch-based polymer. Another example included 11% of a polypropylene having an MFI of 35 g/10 min, 60% of a polypropylene having an MFI of 3 g/10 min, 4% of a maleic anhydride modified polypropylene compatibilizer, and 25% of the high molecular weight starch-based polymer. Another example included 6% of a polypropylene having an MFI of 35 g/10 min, 65% of a polypropylene having an MFI of 3 g/10 min, 4% of a maleic anhydride modified polypropylene compatibilizer, and 25% of the starch-based polymer. Such examples collectively include 60-80% by weight total of two different diluent thermoplastic polymers (e.g., PP). Masterbatches used to form such blends included 50% starch-based polymeric material, 12-42% (42%, 32%, 22%, or 12%) of the thermoplastic material having an MFI of 35 g/10 min, and 0-30% (0%, 10%, 20%, or 30%) of the thermoplastic material having an MFI of 3 g/10 min. While blending of the masterbatch with the additional thermoplastic material can be at about a 1:1 ratio, it will be appreciated that other mixing ratios can be used, to produce different final compositions.

A compatibilizer may optionally be present in the mixture of materials, and is typically provided as a component of the masterbatch, although it could alternatively be provided separately. The compatibilizer can be a modified polyolefin or other modified plastic, such as a maleic anhydride grafted polyolefin (e.g., a maleic anhydride grafted polyethylene, a maleic anhydride grafted polypropylene, a maleic anhydride grafted polybutene, a maleic anhydride grafted polyolefin copolymer, a combination of any of the foregoing, etc.). The compatibilizer can include an acrylate based co-polymer. For example, the compatibilizer can include an ethylene methyl acrylate co-polymer, an ethylene butyl-acrylate co-polymer, or an ethylene ethyl acrylate co-polymer. The compatibilizer can include a poly(vinylacetate) based compatibilizer. In an embodiment, the compatibilizer may be a grafted version of one of the thermoplastic diluent materials (e.g., maleic anhydride grafted polypropylene where the plastic material is polypropylene) or a copolymer (e.g., a block copolymer) where one of the blocks is of the same monomer as the thermoplastic material (e.g., a styrene copolymer where the thermoplastic material is polystyrene or ABS). Selection of a particular compatibilizer often depends on the identity of the thermoplastic diluent resin materials included in the blend, and the compatibilizer (if even present) can be selected to provide good compatibility results between the starch-based material and whatever particular thermoplastic diluent material(s) are being used.

If present, the final blend may include at least 0.5%, at least 1%, at least 2%, at least 3%, at least 4%, at least 5%, no greater than 50%, no greater than 45%, no greater than 40%, no greater than 35%, no greater than 30%, no greater than 25%, no greater than 20%, no greater than 15%, no greater than 10%, no greater than 9%, no greater than 8%, no greater than 7%, no greater than 6%, from 0.5% by weight to 12%, from 2% to 7%, or from 4% to 6% by weight of a compatibilizer. Other ranges defined between any end point values taken from the above or elsewhere from the present disclosure are also contemplated. In some embodiments, no such compatibilizer will be needed. The masterbatch may include double, or another multiplier, relative to such amounts, depending on the blend ratio of the masterbatch to the thermoplastic diluent material with which it is blended. For example, where the final blend may be desired to include 4% compatibilizer, the masterbatch may include 8% compatibilizer, which is to be downblended at a 1:1 ratio.

One or more additional “active” additives as known to be useful in the plastics' industry can be included in the mixture of materials in an amount of at least 0.5%, at least 1%, at least 1.5%, at least 2%, at least 2.5%, at least 3%, at least 4%, of no greater than 10%, no greater than 9%, no greater than 8%, no greater than 7%, no greater than 6%, no greater than 5%, from 0.2% to 12%, from 1% to 10%, from 0.5% to 4%, or from 2% by weight to 6% by weight of the mixture.

By way of example, a directional alignment extrusion process for forming an article may include heating the mixture of materials. The viscosity of the present starch-based materials has been observed to be particularly sensitive to temperature. For example, even though the high molecular weight starch-based materials exhibit viscosity characteristics that are about an order of magnitude greater than what is required to spin conventional starch materials, Applicant has found that this viscosity can be reduced through a combination of actions, including, but not limited to selecting an appropriate process temperature at which the extrusion should occur.

In an implementation, during extrusion, the mixture of materials can be heated to a temperature above the melting point of the polypropylene or other diluent thermoplastic polymers of the blend. For example, many polypropylenes may melt at or above about 160° C., while many polyethylenes may melt at or above about 110° C. By way of example, the temperature may be at least 130° C., at least 140° C., at least 150° C., at least 155° C., at least 160° C., at least 165° C., at least 170° C., at least 175° C., at least 180° C., at least 185° C., no greater than 250° C., no greater than 230° C., no greater than 225° C., no greater than 220° C., no greater than 210° C., no greater than 205° C., no greater than 200° C., no greater than 195° C., from 180° C. to 210° C., from 185° C. to 205° C., or from 185° C. to 200° C. (e.g., 190° C. or 195° C.). Other ranges defined between any end point values taken from the above or elsewhere from the present disclosure are also contemplated. While typical polypropylene processes may heat to about 230° C.-250° C., such may be too high for the present compositions, where it is desired to minimize thermally induced degradation of the starch-based polymeric material. As such, in at least some embodiments, it is important to maintain temperature during extrusion and elsewhere in the spinning system to not exceed 210° C., or even 200° C. One might think such lower temperatures would make extrusion more difficult, as viscosity increases at relatively lower temperatures, although extrusion is possible with the present compositions at such lower temperatures, which conditions minimize degradation of the starch-based polymeric material.

Heating of such materials may be within a multi-stage extruder, which heats the mixture of materials to a given temperature in each extruder stage, where progressive stages are heated to higher temperature than the preceding stage, e.g., as will be apparent to those of skill in the art. In an embodiment, the temperature of the first stage of such extruder for the blend where heating begins may be in the same range as the temperature of the starch-based material (e.g., NuPlastiQ) in the reactive extrusion process in which it was manufactured.

As noted, it can be important to ensure that the processing temperature at which extrusion occurs is not so high as to be above a degradation temperature of the starch-based polymeric material. As noted, heating can be used to decrease the viscosity of the formulation, and the starch-based materials employed herein exhibit sharp reductions in viscosity with increasing temperature, which greatly aids in ensuring that it is possible to extrude and directionally align material at commercial line speeds, and accompanying high shear rates, without the composition entering melt flow instability.

For example, shear stress is equal to melt (shear) viscosity times shear rate, and it is important that the applied shear stress be maintained below the critical shear stress of the formulation, in order to be able to process the formulation, e.g., at typical commercial processing shear rates of up to 1000 sec⁻¹ or 1500 sec⁻¹. Typical resins (e.g., polypropylene) that are used in directional alignment extrusion processes exhibit critical shear stress values of about 100 kPa, above which severe problems occur, making processing impossible. A few resins exhibit more favorable critical shear stress values of up to perhaps 300 kPa, providing additional latitude when engineering a system, to ensure that the critical shear stress is not exceeded. The presently employed starch-based polymeric materials appear to exhibit critical shear stress values that are higher than the typical 100 kPa limits, and may be as high as 300-400 kPa, offering additional latitude in the engineering of a system, which may allow for higher line speeds, higher starch-based material loading (i.e., the very high viscosity component), while still maintaining the system below the applicable critical shear stress. Even when blended in a masterbatch with a diluent material having relatively lower critical shear stress, the critical shear stress of the masterbatch including the starch-based polymeric material may still be greater than 100 kPa, greater than 125 kPa, such as about 200 kPa. Such a material is a very useful additive, for increasing critical shear stress of a formulation being processed under high shear conditions.

In any case, the mixture of materials including the thermoplastic diluent material and the starch-based material can be heated in one or more chambers of an extruder. In some cases, one or more chambers of the extruder can be heated at different temperatures. The speed of one or more screws of the extruder can be at any desired rate. In an embodiment, the system may be configured as a single screw extruder.

A film or sheet is extruded using the mixture of materials. By way of example, BOPP and other biaxially oriented products begin as extruded webs that are relatively thick because the biaxial orientation and thinning to thin film takes place further downstream starting at the puller roll. The highest quality product is made when the web morphology is carefully controlled with many very small crystallites within the polymer melt. Stress induced crystallization can be carefully managed through fast and uniform cooling as the web is drawn by the puller roll from the die.

In a common process, the web is cast on a chilled roll assisted by an air knife to control the neck-in. Extrusion into a water tank or use of a multiple roll stack can also be used for such. In any case, the relatively heavy, thick, extruded web needs to have sufficient melt strength to overcome sagging, drawdown, excessive neck-in and effects associated with any thickened beading at the edge of the extruded thick sheet or film.

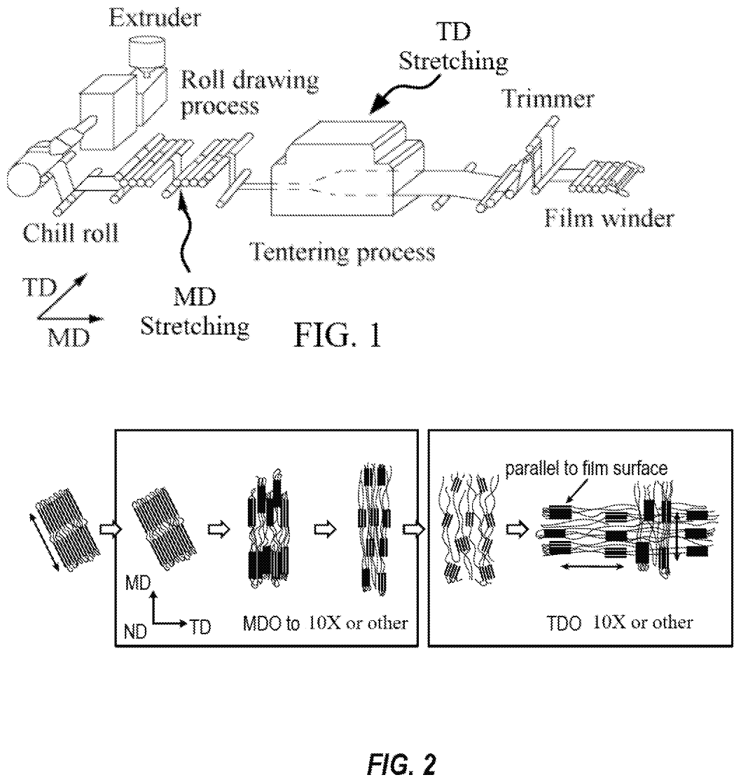

Machine-direction alignment of the molecular chains is typically achieved first, after initial extrusion, as shown by the schematic in FIG. 1. This can be accomplished by taking the as extruded relatively thick web through a plurality of rollers (as many as 12 or more) while heating the extruded film or sheet (e.g., to about 110° C. to 160° C., such as about 130° C.). Pull rollers within the series of rollers actually stretch and pull the extruded sheet or film along the machine-direction axis, resulting in the desired MD orientation of at least some of the molecular chains. By way of example, the applied strain rate may be from 1 to 10 sec⁻¹ (e.g., 5 sec⁻¹), to provide a stretching ratio of greater than 1× to 10× (e.g., 5×), or even higher than 10×. A 2× value would mean that the dimension (e.g., length or width) is two times its initial dimension, after stretching. Machine-direction stretching can be followed by an annealing/relaxing step, e.g., at a temperature of about 110 to 150° C. (e.g., 125° C.) before feeding into the tenter frame where the cross-direction orientation (CDO) is achieved (if the product is being biaxially oriented). The above description, (including temperatures and such) may be particularly exemplary for polypropylene compositions. Those of skill in the art will appreciate that other materials may be processed at somewhat different temperatures and/or other different conditions to achieve the desired directional alignment.

CDO can be applied by a train of clamps which grab the film edges and move on a track away from each other in the cross-direction while maintaining constant machine-direction speed, so as to stretch the material in the cross-direction, orienting at least some of the molecular chains in the cross-direction. The web may pass through one or more ovens at different temperatures as the web undergoes cross-direction alignment. By way of example, the amount of CD orientation or alignment and stretching can be as high as 10× (e.g., greater than 1× to 10×). Applied strain rate may typically be about 0.25 to 5 sec⁻¹ (e.g., 1 sec⁻¹) at a temperature of 140° C. to 170° C. (e.g., 160° C.). The above temperature and other processing parameters may be particularly exemplary for polypropylene. It will be appreciated that different temperatures (e.g., lower temperature) may be used for other materials, such as polyethylene. Of course, it will be appreciated that in a CDO process, no MD stretching may be performed, and in an MDO process, no CD stretching may be performed. It will be appreciated that the above description of the extrusion and alignment process is merely exemplary, and any such extrusion and alignment process can be used with the present compositions that include a starch-based polymeric material. FIG. 2 schematically illustrates information relative to crystal orientation and morphology for such MDO and/or TDO films.

Where a nonwoven is formed, the nonwoven web can be comprised of a single layer or multiple layers. The weight (e.g., basis weight) of such nonwoven layers or webs may be within any desired range. Exemplary weights often range from 10 g/m² (gsm) to 800 gsm, from 10 g/m² (gsm) to 500 gsm, from 10 g/m² (gsm) to 300 gsm, from 10 g/m² (gsm) to 150 gsm, or from 10 to 100 gsm, or from 10-20 gsm.

During such MD and/or CD stretching, the extruded material can also be heated, although typically at a temperature that is less than that provided during extrusion. For example, during such stretching temperature may be near the melting point of the polypropylene or other diluent thermoplastic polymer(s) of the blend. By way of example, the temperature may be at least 100° C., at least 105° C., at least 110° C., at least 115° C., at least 120° C., at least 125° C., no greater than 200° C., no greater than 190° C., no greater than 180° C., no greater than 170° C., no greater than 160° C., from 100° C. to 200° C., from 105° C. to 180° C., from 110° C. to 160° C., or from 120° C. to 150° C. Other ranges defined between any end point values taken from the above or elsewhere from the present disclosure are also contemplated. Particular temperature ranges for extrusion and stretching will be apparent in light of the present disclosure, and may depend on the particular components and fractions thereof included in the formulation. In an embodiment, heating during stretching, after extrusion may be to a temperature slightly below a melting temperature of one or more of the thermoplastic diluent materials (e.g., polypropylenes may typically melt about 160° C.). For example, heating may be to a temperature that is within 50° C., 40° C., 30° C., 20° C., or 10° C. of a melting temperature of a given diluent. As noted above when discussing extrusion temperatures, care should be taken to ensure that the temperature is not so high as to result in thermal degradation of the starch-based polymeric material.

When subjected to biodegradation testing (e.g., under any applicable ASTM standard, such as ASTM D-5511, ASTM D-5526, ASTM D-5338, or ASTM D-6691), the articles described herein may exhibit significant biodegradation. Under such testing, and within a given time period (e.g., 180 days, 365 days (1 year), 2 years, 3 years, 4 years, or 5 years, the articles may show substantial biodegradation of the total polymeric content, including typically non-biodegradable polymer components. Articles made from the compositions of this invention may show biodegradation that is greater than the high molecular weight starch-based material content thereof, as a result of the thermoplastic material(s) also biodegrading. Such results are novel, in that all prior art blends including non-biodegradable plastic material (e.g., polypropylene) and starch-based materials known to Applicant exhibit biodegradation values that are always no more than (typically less than) the starch-based material content of the blended material. The present invention addresses biodegradability in an entirely different way, rendering the polypropylene and similar “inert” polymers susceptible to microbial assimilation. Of course, it is also within the scope of the present invention to incorporate or otherwise use PLA, PBAT or other more “green” polymers in the blend, e.g., as the thermoplastic material having particular selected melt flow index values. Biodegradation of polypropylene such as that included in the current blends has been confirmed by various third party testing using industry recognized respirometry-based biodegradation tests (e.g., ASTM D-5338, ASTM D-5526, ASTM D-5511, ASTM D-6991).

Particularly when subjecting the articles to testing simulating biodegradation under anaerobic digester or industrial compost conditions for 180 days, 365 days (1 year), 2 years, 3 years, or 5 years, the biodegradation can be greater than the weight percent of starch-based materials within the article, and where no other recognized biodegradable materials are included therein. In other words, inclusion of the described starch-based materials can result in at least some biodegradation of the other thermoplastic material(s) (which materials alone may not significantly biodegrade, absent the starch-based material). Inclusion of as little as 1% NuPlastiQ is sufficient to trigger significant biodegradation of the various components included in the blend. Where a component included in the blend is already biodegradable to some degree (e.g., various polyesters), NuPlastiQ tends to increase the rate and/or extent of biodegradability for such component.

For example, an article such as a directionally aligned film or sheet that is formed from a blend of the starch-based materials and PP may exhibit biodegradation after such periods of time that is at least 5%, 10%, 15%, or 20% more than the weight fraction of the starch-based materials in the film, even where no other recognized biodegradable components are present to any significant degree, indicating that significant fractions of the PP (normally not biodegradable) is actually being biodegraded, with the starch-based material. Such results are surprising, and particularly advantageous. Such results are described in detail in various of the applications already incorporated by reference. Such characteristics are not inherent in any prior art conventional blends formed from starch-based material and polypropylene known to Applicant.

When subjected to biodegradation testing, an article made from the compositions of this invention having an amount of starch-based material and the other thermoplastic material as described herein can exhibit excellent biodegradation. For example, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, or even at least 95% of the non-starch-based material (e.g., the “other” plastic material, such as polypropylene, another polyolefin, or other plastic that is non-biodegradable on its own) may biodegrade over a period of at least about 1 year, at least about 2 years, at least about 3 years, or at least about 5 years when tested under any of ASTM D-5338, ASTM D-5526, ASTM D-5511 or ASTM D-6691. The present disclosure explicitly contemplates each of the above biodegradation percentages within each of the above identified time periods. Such biodegradation is particularly remarkable and advantageous.

With increased time, the amount of biodegradation can be very high, such that in at least some implementations, substantially the entire article biodegrades, e.g., biodegradation of at least about 85%, at least about 90%, or at least about 95% relative to biodegradation of a positive control (e.g., cellulose) under the given test standard. Such results may be achieved within 180 days, or 365 days (1 year), within 2 years, within 3 years, within 5 years, or other period. Biodegradation may be considered to be substantially complete where the amount of biodegradation in the article is at least 90% of that achieved in a cellulose positive control, tested under the same conditions, for the same time period. Inclusion of as little as 1% NuPlastiQ is sufficient to trigger significant biodegradation of the various components included in the blend. Where a component included in the blend is already biodegradable to some degree (e.g., any of various compostable or biodegradable polyesters such as PLA, PBAT, PBS, PHA or PCL), NuPlastiQ tends to increase the rate and/or extent of biodegradability for such component.

### IV. Examples

### Example 1

An exemplary formulation with ranges for various components is shown in Table 2 below.

TABLE 2

| Component | Function | Amount |
|---|---|---|
| PP (MFI 1) | Matrix | >5% |
| PP (MFI 2, such an | Other Viscosity | >5%, such as |
| MFI of 2-5) | modifier | up to 50% or |
| | (MFI 2 < MFI 1) | even up to 75% |
| random | Elastic | 0-15% |
| poly(propylene/ | Component | |
| ethylene) copolymer | | |
| Long Chain Branched PP | Strain Hardener | 0-10% |
| High MW PE | Strain Hardener | 0-5% |
| High MW Polyacryl- | Strain Hardener | 0-1% |
| amide | | |
| Maleic Anhydride PP | Compatibilizer | 0-10% |
| Starch-Based Polymer | Starch-based | 1-60% |
| | Component | |

Various starch-based polymeric materials were evaluated rheologically for the present application, and one particular starch-based polymeric material was selected for processes as described herein based on measured characteristics. The base starch, or majority starch in the evaluated materials was a corn starch (Corn1 or Corn2). Corn1 is an unmodified starch from native yellow dent corn. Corn2 is a modified corn starch. In the formulation used in the examples described herein, the starch-based polymeric material was formed from just a single starch (Corn2), rather than a mixture of two different starches (Corn1 or Corn2+Potato). The formed starch-based materials exhibited very high weight average molecular weights, e.g., as described herein. In an embodiment the molecular weight (e.g., number average and/or weight average molecular weight) of the starting starch material (e.g., corn starch) may actually be less than the molecular weight of the resulting starch-based polymeric material, after reactive extrusion with the plasticizer, as determined through size exclusion chromatography. In other words, in some cases, the reactive extrusion process may actually result in an increase in average molecular weight, for example with a decrease in polydispersity. By way of example, analysis on Corn2 (a modified corn starch) shows the following molecular weight characteristics.

By way of example, GPC analysis on Corn 2 (a modified corn starch) shows the following molecular weight characteristics.

TABLE 3

| | Run 1 | Run 2 |
|---|---|---|
| Mn | 3,410,000 | 2,230,000 |
| Mw | 8,700,000 | 7,190,000 |
| Mz | 28,900,000 | 82,000,000 |

The polydispersity (Mw/Mn) for Run 1 and Run 2 for this modified corn starch material was 2.55 and 3.22, respectively. An exemplary starch-based polymeric material formed from the corn starch of Table 3 and a plasticizer (e.g., glycerin) included the following molecular weight characteristics, shown in Table 4. The formed starch-based polymeric material had a polydispersity (Mw/Mn) of 1.99. The reported Mz values refer to the “third moment” molecular weight, which has more weighting with regards to higher molecular weights.

TABLE 4

| | Starch-Based |
|---|---|
| | Polymeric Material |
| Mn | 5,370,000 |
| Mw | 10,700,000 |
| Mz | 33,400,000 |

A BiologiQ Processing Index (BPI) based on the viscosity of such components used in the formulation can be calculated or measured at such conditions (e.g., 200 sec⁻¹, at 190° C., with a 1 mm die, having a L/D=30), for use as a benchmark, in evaluating various components and resulting formulations. BPI can be a good process control tool. Additional rheological details on various formulations is found in U.S. application Ser. No. 17/327,536 (21132.31.1), U.S. application Ser. No. 17/327,577 (21132.31.2), and U.S. application Ser. No. 17/327,590 (21132.31.3), each of which is herein incorporated by reference in its entirety.

In addition to the benefits provided by increased sustainability provided by replacing some of the conventional thermoplastic resin material of a formulation with the present starch-based polymers, other benefits are also provided, by making such adjustments to the formulation. For example, extrusion rate may be improved by extending the onset of melt flow instability at higher shear rates (increased output). In addition, the rheological data indicate an advantageous high critical shear stress associated with such high molecular weight starch-based materials, which can provide an increase over the typical onset of melt flow instability at about 100 kPa in the case of polypropylene. For example, if the starch-based polymeric material itself may exhibit a critical shear stress of 300 kPa or more, its inclusion even at a level of 25% in a formulation being extruded and directionally aligned may result in an increase of the critical shear stress from about 100 kPa for the polypropylene composition alone to perhaps 150 kPa for the blend including the starch-based polymeric material. Such would allow processing at increased shear rates, higher line speeds, etc., without onset of melt flow instability.

A formulation that does not include diluents with a melt-flow index greater than 35 g/10 min would be particularly advantageous (e.g., including diluents with MFI values of 3 g/10 min and 35 g/10 min), and suitable for extrusion and directional alignment.

A formulation including 25% of the starch-based material, 60% 3 MFI PP, 11% 35 MFI PP, and 4% maleic anhydride PP compatibilizer can be used in extruding and biaxially orienting polypropylene film (i.e., BOPP).

Additional formulations were also prepared, e.g., with lower MFI components. Table 5 below shows one such formula.

TABLE 5

| Component | Amount | BPI |
|---|---|---|
| High MW Starch-Based Material | 50% | 478 |
| PP (MFI 35) | 42% | 246 |
| Compatibilizer | 8% | 31 |

The rheological properties of the blend gives a calculated BPI of 345 Pa·s. In order to provide greater melt strength the formulations shown below in Tables 6-8 were prepared.

TABLE 6

| Component | Amount | BPI |
|---|---|---|
| High MW Starch-Based Material | 50% | 478 |
| PP (MFI 35) | 32% | 246 |
| PP (MFI 3) | 10% | 529 |
| Compatibilizer | 8% | 31 |

TABLE 7

| Component | Amount | BPI |
|---|---|---|
| High MW Starch-Based Material | 50% | 478 |
| PP (MFI 35) | 22% | 246 |
| PP (MFI 3) | 20% | 529 |
| Compatibilizer | 8% | 31 |

TABLE8

| Component | Amount | BPI |
|---|---|---|
| High MW Starch-Based Material | 50% | 478 |
| PP (MFI 35) | 12% | 246 |
| PP (MFI 3) | 30% | 529 |
| Compatibilizer | 8% | 31 |

The formulations of Tables 6-8 provided calculated BPI values of 373 Pa·s, 401 Pa·s, and 430 Pa·s, respectively. Each of the formulations of Tables 5-8 can be processed in a directional alignment extrusion process, e.g., to form BOPP, by mixing the masterbatch formulation of the given table, at a desired mixing ratio (e.g., 1:1) with 3 MFI PP. Resulting BPI values for each such example, when mixed at a 1:1 ratio with the 3 MFI PP (BPI of 529 Pa·s) are 427 Pa·s, 451 Pa·s, 465 Pa·s, and 479 Pa·s, for such examples formulated using the masterbatch of Tables 5-8, respectively. Such may be processed at temperatures and other conditions as described herein, and/or as will be appreciated by those familiar with such directional alignment extrusion processes. By way of example, extrusion may occur at a temperature of from 190° C. to 215° C., or from 195° C. to 210° C. (e.g., 200° C. to 205° C.). Such temperatures are significantly lower than the typical temperature of about 250° C. for similar processing, of just the polypropylene, alone, which could provide energy savings, etc.

Features from any of the disclosed embodiments or claims may be used in combination with one another, without limitation. It will be appreciated that the scope of the present disclosure extends to rewriting any of the claims to depend from any other claim, to include multiple dependencies from any combination of other claims, and/or to combine multiple claims together. Such also extends to any individual or combinations of features of any of the embodiments as described in the Summary section, as well as the Detailed Description section. The scope of the present disclosure extends to inserting and/or removing any feature or combination of features from any claim or described embodiment, for insertion into another claim or embodiment, or drafting of a new claim including any combination of such features from any other claim(s) or embodiments.

It will also be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

1. A method for extruding and directionally aligning molecular chains of a composition that includes a starch-based polymeric material, the method comprising:
providing a starch-based polymeric material; and
melt extruding the composition through a die to form a film or sheet, and stretching the film or sheet while heated in at least one of a machine-direction or a cross-direction to align molecular chains of the composition in at least one of the machine-direction or the cross-direction, wherein the composition exhibits a shear stress through the die that is below an onset of melt flow instability of the composition, to produce directionally aligned films or sheets comprising the starch-based polymeric material.

2. The method of claim 1, wherein the composition is a blend of the starch-based polymeric material and at least one thermoplastic polymer.

3. The method of claim 2, wherein the at least one thermoplastic polymer includes a thermoplastic polymer that is not normally biodegradable.

4. The method of claim 3, wherein the thermoplastic polymer that is not normally biodegradable comprises a polyolefin.

5. The method of claim 4, wherein the thermoplastic polymer that is not normally biodegradable comprises polypropylene.

6. The method of claim 4, wherein the thermoplastic polymer that is not normally biodegradable comprises polyethylene.

7. The method of claim 1, wherein a weight average molecular weight of the starch-based polymeric material is at least 2 million.

8. The method of claim 1, wherein a weight average molecular weight of the starch from which the starch-based polymeric material is formed is from 3 to 10 million.

9. The method of claim 1, wherein a weight average molecular weight of the starch from which the starch-based polymeric material is formed is from 5 to 7 million.

10. The method of claim 1, wherein a weight average molecular weight of the starch-based polymeric material is from 3 to 20 million.

11. The method of claim 1, wherein a weight average molecular weight of the starch-based polymeric material is from 5 to 18 million.

12. The method of claim 1, wherein starch-based polymeric material is included in the composition in an amount of at least 0.5%.

13. (canceled)

14. The method of claim 1, wherein starch-based polymeric material is included in the composition in an amount from 10% to 40%.

15. (canceled)

16. The method of claim 1, wherein the extruded material is MD oriented or CD oriented.

17. (canceled)

18. The method of claim 1, wherein the extruded material is biaxially oriented in both the MD and the CD directions.

19. (canceled)

20. (canceled)

21. The method of claim 18, wherein the extruded material is a laminate comprising at least one of BOPP or BOPE.

22. The method of claim 1, wherein the film or sheet while heated is stretched to at least 2× in at least one of the MD or CD directions.

23. The method of claim 1, wherein the starch-based polymeric material has a water content, including any bound water, of no more than 2%.

24. (canceled)

25. The method of claim 1, wherein the starch-based polymeric material is included in the composition in an amount of up to 60% by weight.

26. (canceled)

27. (canceled)

28. The method of claim 2, wherein the at least one thermoplastic polymer includes a thermoplastic polymer that is biodegradable.

29. The method of claim 28, wherein the thermoplastic polymer that is biodegradable comprises at least one of PLA, PBAT, PBS, PHA or PCL.

30. The method of claim 2, wherein starch-based polymeric material is included in the composition in an amount of at least 1% by weight, such 1% by weight starch-based polymeric material being sufficient to increase a rate and/or extent of biodegradation of the at least one thermoplastic polymer.

31. A polymeric blend for use in forming directionally oriented film or sheet, the blend comprising:
a starch-based polymeric material;
a thermoplastic polymeric material having a melt flow index configured to plasticize the starch-based polymeric material;
wherein starch-based material is intimately dispersed within the thermoplastic polymeric material;
wherein the blend exhibits a critical shear stress sufficient to permit extrusion of the blend through a die, with shear stress remaining below onset of melt flow instability;
wherein the blend exhibits sufficient melt strength to permit directional alignment of the blend in a heated condition after extrusion of the blend through the die, to produce directionally aligned films or sheets comprising the starch-based polymeric material.

32. (canceled)

33. (canceled)

34. (canceled)

35. (canceled)

36. (canceled)

37. A directionally aligned film or sheet material in which polymer molecular chains are aligned, the film or sheet material comprising:
a starch-based polymeric material; and
a thermoplastic polymeric material having a melt flow index that is configured to plasticize the starch-based polymeric material and provide melt strength characteristics needed during manufacture;
wherein within the film or sheet, molecular chains of the thermoplastic polymeric material, the starch-based polymeric material, or both are substantially aligned in the machine-direction, the cross-direction, or both directions as a result of stretching during manufacture of a heated blend including the thermoplastic polymeric material and the starch-based polymeric material.

38. (canceled)

39. A method for increasing the critical shear stress threshold of an extrusion formulation, the method comprising:
providing a thermoplastic extrusion formulation having an initial critical shear stress of less than 125 kPa;
adding a starch-based polymeric material having a critical shear stress that is greater than the initial critical shear stress of the thermoplastic extrusion formulation to the thermoplastic formulation, the starch-based polymeric material increasing the initial critical shear stress of the formulation.

40. (canceled)

41. (canceled)

42. (canceled)

43. A method for increasing an initial critical shear stress threshold as compared to a polyolefin of a starch material/polyolefin blend, the method comprising:
employing as the starch material a starch-based polymeric material having a critical shear stress value of greater than 125 kPa, the starch-based polymeric material increasing an initial critical shear stress of the formulation to be greater than that of the polyolefin alone.
